(19) United States
(12) Patent Application Publication
(10) Pub. No.: US 2025/0193524 A1
(43) Pub. Date: Jun. 12, 2025

(54) CONTROL DEVICE, IMAGING SYSTEM, CONTROL METHOD, AND CONTROL PROGRAM

(71) Applicant: FUJIFILM Corporation, Tokyo (JP)

(72) Inventors: Tetsuya FUJIKAWA, Saitama-shi (JP); Tomoharu SHIMADA, Saitama-shi (JP); Masahiko SUGIMOTO, Saitama-shi (JP)

(73) Assignee: FUJIFILM Corporation, Tokyo (JP)

(21) Appl. No.: 19/054,903

(22) Filed: Feb. 16, 2025

Related U.S. Application Data
(63) Continuation of application No. PCT/JP2023/026845, filed on Jul. 21, 2023.

(30) Foreign Application Priority Data
Aug. 24, 2022 (JP) 2022-133011

(51) Int. Cl. H04N 23/695; H04N 23/67; H04N 23/69

(52) U.S. Cl. CPC H04N 23/695; H04N 23/67; H04N 23/69

(57) ABSTRACT

A control device includes: a processor that controls an imaging apparatus and an imaging direction changing device capable of changing an imaging direction of the imaging apparatus, and the processor is configured to: set a first imaging path, which is an imaging path of a first subject, based on imaging information at discrete positions within the first subject and subject information related to the first subject; and control imaging of the first subject based on the first imaging path.

### CROSS REFERENCE TO RELATED APPLICATION

This is a continuation of International Application No. PCT/JP2023/026845 filed on Jul. 21, 2023, and claims priority from Japanese Patent Application No. 2022-133011 filed on Aug. 24, 2022, the entire disclosures of which are incorporated herein by reference.

### BACKGROUND OF THE INVENTION

### 1. Field of the Invention

The present invention relates to a control device, an imaging system, a control method, and a computer readable medium storing a control program.

### 2. Description of the Related Art

JP3220181Y discloses an overhead line imaging apparatus comprising a telescope, a video camera device, and a pan-tilt head mechanism, in which the telescope and the video camera device are supported by the pan-tilt head mechanism so as to be rotatable in a yaw (horizontal) direction and a tilt (up and down) direction, and the pan-tilt head mechanism includes a yaw direction driving unit and a tilt direction driving unit.

JP2020-191523A discloses an unmanned aerial vehicle configured to perform divided imaging of elevated transmission lines with an imaging camera, determine that imaging has failed in a case where frame-out or focus shift of the elevated transmission lines has occurred, and perform re-imaging of a location where the imaging has failed.

JP2017-077080A discloses an unmanned flying object having a configuration in which a landscape image of a periphery is captured by an imaging unit, a catenary curve of an electric wire suspended between two steel towers is calculated based on the landscape image, a flight path is determined along the catenary curve, and a degree of corona discharge due to damage or deterioration of the electric wire is detected.

JP2019-144153A discloses a method of reproducing a shape of an electric wire by acquiring data of a point group related to a power transmission line installed between a pair of adjacent steel towers by a drone or the like, calculating a least square plane, performing parallel projection of the point group to the least square plane, rotating the point group subjected to the parallel projection to an orthogonal coordinate system, and finally calculating a suspension curve (catenary curve) of the overhead power transmission line suitable for the point group after rotation.

### SUMMARY OF THE INVENTION

One embodiment according to the technique of the present disclosure provides a control device, an imaging system, a control method, and a computer readable medium storing a control program that can efficiently perform divided imaging of a subject.

(1)

A control device comprising:
a processor that controls an imaging apparatus and an imaging direction changing device capable of changing an imaging direction of the imaging apparatus, in which
the processor is configured to:
   set a first imaging path, which is an imaging path of a first subject, based on imaging information at discrete positions of the first subject and subject information related to the first subject; and
   control imaging of the first subject based on the first imaging path.
      (2)

The control device according to (1), in which
the subject information is a shape of the first subject in a two-dimensional plane.
   (3)

The control device according to (1), in which
the imaging information is a control value based on an angle of view of the imaging apparatus for imaging the discrete positions.
   (4)

The control device according to (3), in which
the imaging information includes a control value of the imaging direction changing device for imaging the discrete positions.
   (5)

The control device according to (3), in which
the imaging information includes a distance between the first subject and the imaging apparatus for imaging the discrete positions.
   (6)

The control device according to any one of (3) to (5), in which
the imaging information includes a focus position of the imaging apparatus for imaging the discrete positions.
   (7)

The control device according to (6), in which
the imaging apparatus includes a zoom lens, and
the processor is configured to acquire the focus position of the imaging apparatus by causing the imaging apparatus to execute distance measurement in a state where the zoom lens is set to a telephoto region.
   (8)

The control device according to any one of (1) to (7), in which
the first imaging path includes a control value for dividing and imaging the first subject.
   (9)

The control device according to any one of (1) to (8), in which
the discrete positions include at least any one of three adjacent points among a plurality of points of the first subject, or two points at an end and one point different from the two points among the plurality of points.
   (10)

The control device according to (9), in which
the two points at the end are located in an end region of the first subject.
   (11)

The control device according to any one of (1) to (10), in which
the discrete positions are calculated based on an analysis result of an image obtained by imaging the first subject.
   (12)

The control device according to any one of (1) to (11), in which
the processor is configured to:
   acquire difference information between a first position of the first subject and a second position of a second subject;
   set a second imaging path, which is an imaging path of the second subject, based on the first imaging path and the difference information; and
   control imaging of the second subject based on the second imaging path.
      (13)

The control device according to (12), in which
the first position is a position of a region of the first subject close to the imaging apparatus, and
the second position is a position of a region of the second subject close to the imaging apparatus.
   (14)

The control device according to (12) or (13), in which
the first subject is a subject closer to the imaging apparatus than the second subject.
   (15)

The control device according to any one of (12) to (14), in which
the processor is configured to:
   calculate, in a case where it is determined that the imaging in the second imaging path is not possible within a movable range of the imaging direction changing device, an installation position of the imaging direction changing device at which the imaging in the second imaging path is possible within the movable range of the imaging direction changing device; and
   output the installation position.
      (16)

The control device according to any one of (12) to (15), in which
the processor is configured to:
   generate a composite image by combining a plurality of captured images of the first subject obtained by performing imaging in the first imaging path by the imaging apparatus and a plurality of captured images of the second subject obtained by performing imaging in the second imaging path by the imaging apparatus, and output the composite image to a display device; and
   generate the composite image in which a subject closer to the imaging apparatus among the first subject and the second subject is seen in front of a subject farther from the imaging apparatus among the first subject and the second subject, based on distance information between the first subject and the imaging apparatus and distance information between the second subject and the imaging apparatus.
      (17)

The control device according to any one of (1) to (16), in which
the imaging apparatus includes a zoom lens,
the first imaging path includes information on an imaging distance, and
the processor is configured to change a zoom amount of the zoom lens in accordance with the imaging distance in control of the imaging of the first subject based on the first imaging path.
   (18)

The control device according to (17), in which
the zoom amount is an amount corresponding to a set resolution.
   (19)

The control device according to any one of (1) to (18), in which
the processor is configured to store information related to an imaging angle of the first subject based on the first imaging path in a storage device in association with the first subject.
   (20)

The control device according to any one of (1) to (19), in which
the processor is configured to:
   generate a composite image obtained by combining each of captured images obtained by performing imaging in the first imaging path by the imaging apparatus, and output the composite image to a display device;
   receive designation of a position in the composite image; and
   output a captured image corresponding to the designated position among the captured images to the display device.
      (21)

The control device according to any one of (1) to (20), in which
the processor is configured to store information related to a plurality of times of imaging of the first subject controlled in a state where the imaging apparatus is installed at different locations in a storage device in association with the first subject.
   (22)

The control device according to any one of (1) to (21), in which
the first subject is a linear structure that does not fit entirely within a set angle of view.
   (23)

An imaging system comprising:
an imaging apparatus;
an imaging direction changing device capable of changing an imaging direction of the imaging apparatus; and
a control device that controls the imaging apparatus and the imaging direction changing device, in which
a processor included in the control device is configured to:
   set a first imaging path, which is an imaging path of a first subject, based on imaging information at discrete positions of the first subject and subject information related to the first subject; and
   control imaging of the first subject based on the first imaging path.
      (24)

A control method of a control device that controls an imaging apparatus and an imaging direction changing device capable of changing an imaging direction of the imaging apparatus, the method comprising:
via a processor of the control device,
setting a first imaging path, which is an imaging path of a first subject, based on imaging information at discrete positions of the first subject and subject information related to the first subject; and
controlling imaging of the first subject based on the first imaging path.
   (25)

A control program of a control device, stored in a computer readable medium, that controls an imaging apparatus and an imaging direction changing device capable of changing an imaging direction of the imaging apparatus, the program causing a processor of the control device to execute a process comprising:
setting a first imaging path, which is an imaging path of a first subject, based on imaging information at discrete positions of the first subject and subject information related to the first subject; and
controlling imaging of the first subject based on the first imaging path.

According to an aspect of the present invention, it is possible to provide a control device, an imaging system, a control method, and a computer readable medium storing a control program capable of efficiently performing divided imaging of a subject.

### BRIEF DESCRIPTION OF THE DRAWINGS

FIG. 1 is a diagram showing an example of an imaging system 1 equipped with a control device 60 of the present embodiment.

FIG. 2 is a diagram showing an example of revolution of a camera 10 in a pitch direction by a revolution mechanism 16.

FIG. 3 is a diagram showing an example of the revolution of the camera 10 in a yaw direction by the revolution mechanism 16.

FIG. 4 is a block diagram showing an example of configurations of an optical system and an electrical system of the camera 10.

FIG. 5 is a diagram showing an example of a configuration of an electrical system of the revolution mechanism 16 and a management apparatus 11.

FIG. 6 is a diagram showing a case where a power transmission line 102 connected between steel towers 101a and 101b is inspected by the camera 10.

FIG. 7 is a flowchart showing an example of imaging processing by a CPU 60A.

FIG. 8 is a flowchart showing an example of automatic imaging of the first power transmission line executed based on auxiliary information set by a worker.

FIG. 9 is a flowchart showing another example of the automatic imaging of the first power transmission line executed based on the auxiliary information set by the worker.

FIG. 10 is a flowchart showing an example of the automatic imaging of the first power transmission line executed based on auxiliary information set by image analysis.

FIG. 11 is a flowchart showing an example of automatic imaging of the second and subsequent power transmission lines executed based on the auxiliary information set by the worker.

FIG. 12 is a flowchart showing an example of the automatic imaging of the second and subsequent power transmission lines executed based on the auxiliary information set by the image analysis.

FIG. 13 is a diagram showing an end part of a power transmission line designated in a case where the second and subsequent power transmission lines are automatically imaged.

FIG. 14 is a diagram in which power transmission lines 132a and 132b connected between the steel towers 101a and 101b and the camera 10 that images the power transmission lines 132a and 132b are viewed from above.

FIG. 15 is a diagram in which the steel towers 101a and 101b and the power transmission lines 132a and 132b shown in FIG. 14 are viewed from a camera 10 side.

FIG. 16 is a diagram in which the camera 10 that images the steel tower 101a and power transmission lines 102a, 102b, 103a, 103b, 104a, and 104b is viewed from a lateral direction of the camera 10.

FIG. 17 is a diagram in which the camera 10 that images the steel towers 101a and 101b and power transmission lines 142a, 142b, 143a, and 143b is viewed from the rear of the camera 10.

FIG. 18 is a flowchart for calculating an imaging distance of the camera 10 for imaging the power transmission line.

FIG. 19 is a diagram showing an example of an image obtained by performing zoom imaging at a plurality of positions where imaging distances are different.

FIG. 20 is a diagram showing a state in which a subject is imaged by a camera.

FIG. 21 is a diagram imaging two power transmission lines disposed to overlap each other in a front-rear direction.

FIG. 22 is a diagram showing a composite image 194 of the two power transmission lines disposed to overlap each other in the front-rear direction.

FIG. 23 is a diagram showing a state in which a power transmission line is imaged by cameras 10a and 10b installed at two locations.

FIG. 24 is a diagram showing an example of an aspect in which an information processing program for management control is installed in the control device 60 of the management apparatus 11 from a storage medium in which the information processing program is stored.

### DESCRIPTION OF THE PREFERRED EMBODIMENTS

Hereinafter, an example of an embodiment of the present invention will be described with reference to the drawings.

### <Imaging System of Embodiment>

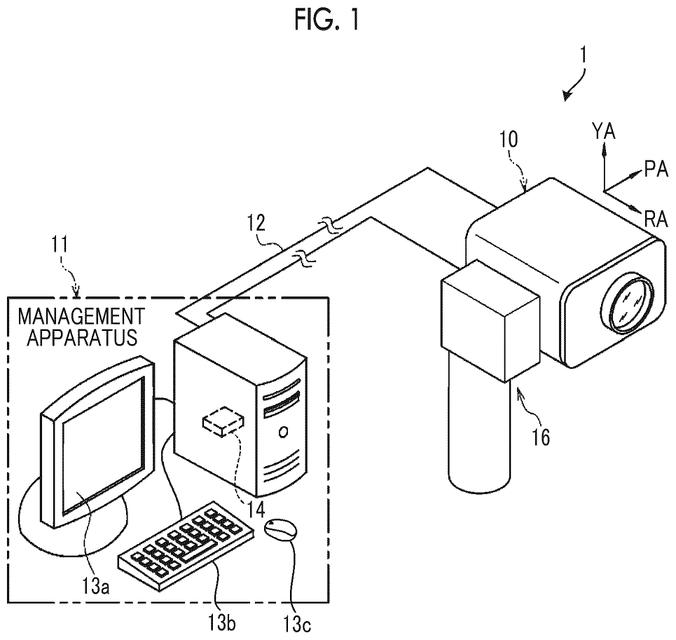

FIG. 1 is a diagram showing an example of an imaging system 1 equipped with a control device of the present embodiment. As an example, as shown in FIG. 1, an imaging system 1 includes a camera 10 and a management apparatus 11. The camera 10 is an example of an imaging apparatus according to the embodiment of the present invention.

The camera 10 is a camera for inspecting a facility (infrastructure) that is the basis of life and industrial activities. The camera 10 performs inspection of a linear structure, for example, a power transmission line. In addition, the camera 10 may perform inspection of, for example, a tree of artificial afforestation (a tree that is arranged at regular intervals and whose shape can be predicted). A camera capable of telephoto imaging, a camera having ultra-high resolution, and the like are used as the camera 10. In addition, a wide-angle camera may be used as the camera 10. The camera 10 is installed via a revolution mechanism 16 described below, and images an imaging target, which is a subject. The camera 10 transmits, to the management apparatus 11 via a communication line 12, a captured image obtained by the capturing and imaging information related to the capturing of the captured image.

The management apparatus 11 comprises a display 13a, a keyboard 13b, a mouse 13c, and a secondary storage device 14. Examples of the display 13a include a liquid crystal display, a plasma display, an organic electro-luminescence (EL) display, and a cathode ray tube (CRT) display. The display 13a is an example of a display device according to the embodiment of the present invention.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The management apparatus 11 receives the captured image or the imaging information, which is transmitted from the camera 10, and displays the received captured image or imaging information on the display 13a or stores the received captured image or imaging information in the secondary storage device 14.

The management apparatus 11 performs imaging control of controlling the imaging performed by the camera 10. For example, the management apparatus 11 communicates with the camera 10 via the communication line 12 to perform the imaging control. The imaging control is control for setting, to the camera 10, an imaging parameter for the camera 10 to perform the imaging and causing the camera 10 to execute the imaging. The imaging parameters include a parameter related to exposure, a parameter of a zoom position, and the like.

In addition, the management apparatus 11 controls the revolution mechanism 16 to perform control of the imaging direction (pan and tilt) of the camera 10. For example, the management apparatus 11 sets the revolution direction, the revolution amount, the revolution speed, and the like of the camera 10 in response to an operation of the keyboard 13b and the mouse 13c, or a touch operation of the display 13a on the screen.

### <Revolution of Camera 10 by Revolution Mechanism 16>

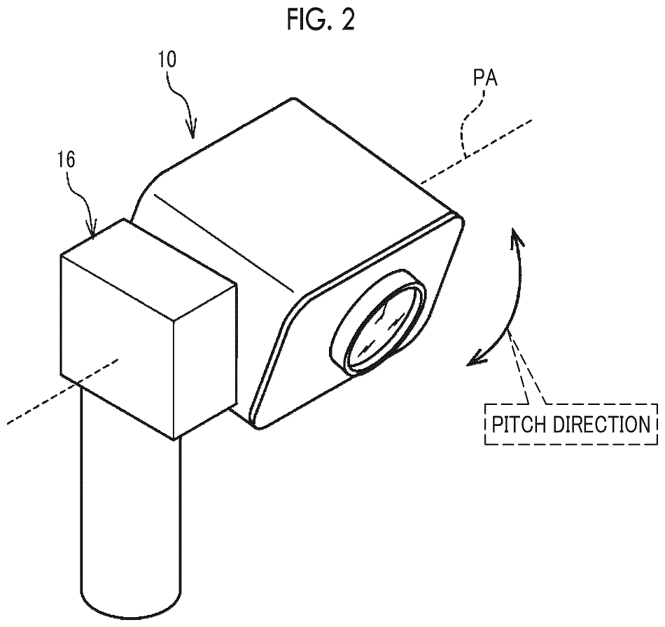

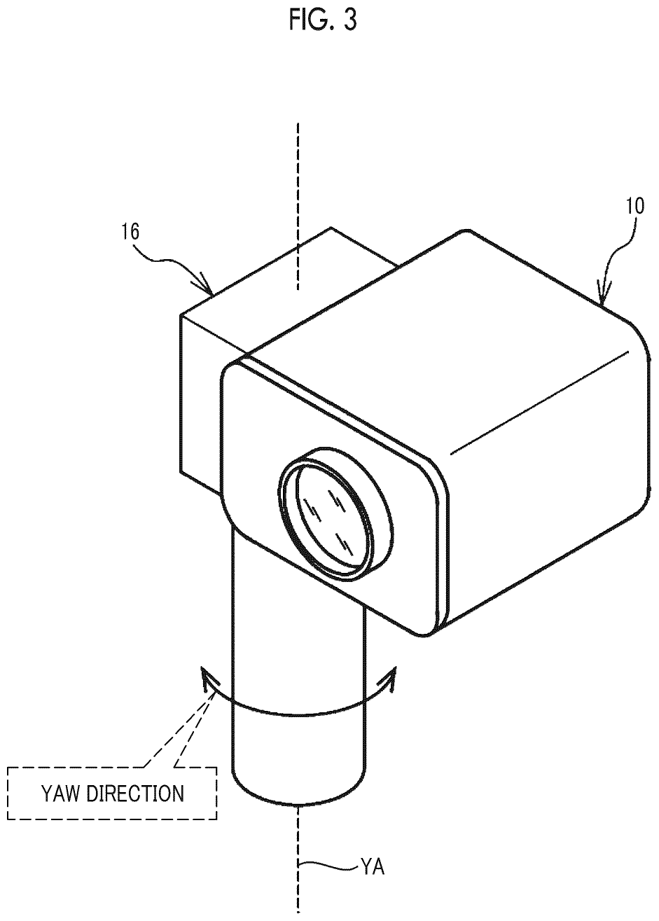

FIG. 2 is a diagram showing an example of revolution of the camera 10 in a pitch direction by the revolution mechanism 16. FIG. 3 is a diagram showing an example of the revolution of the camera 10 in a yaw direction by the revolution mechanism 16. The camera 10 is attached to the revolution mechanism 16. The revolution mechanism 16 can change the imaging direction of the camera 10 by revolving the camera 10. The revolution mechanism 16 is an example of an imaging direction changing device according to the embodiment of the present invention.

Specifically, the revolution mechanism 16 is a two-axis revolution mechanism that enables the camera 10 to revolve in a revolution direction (pitch direction) that intersects the yaw direction and that has a pitch axis PA as a central axis, as shown in FIG. 2 as an example, and in a revolution direction (yaw direction) that has a yaw axis YA as a central axis, as shown in FIG. 3 as an example. An example is shown in which the two-axis revolution mechanism is used as the revolution mechanism 16 according to the present embodiment, but the technique of the present disclosure is not limited thereto. A three-axis revolution mechanism or a one-axis revolution mechanism may be used.

### <Configuration of Optical System and Electrical System of Camera 10>

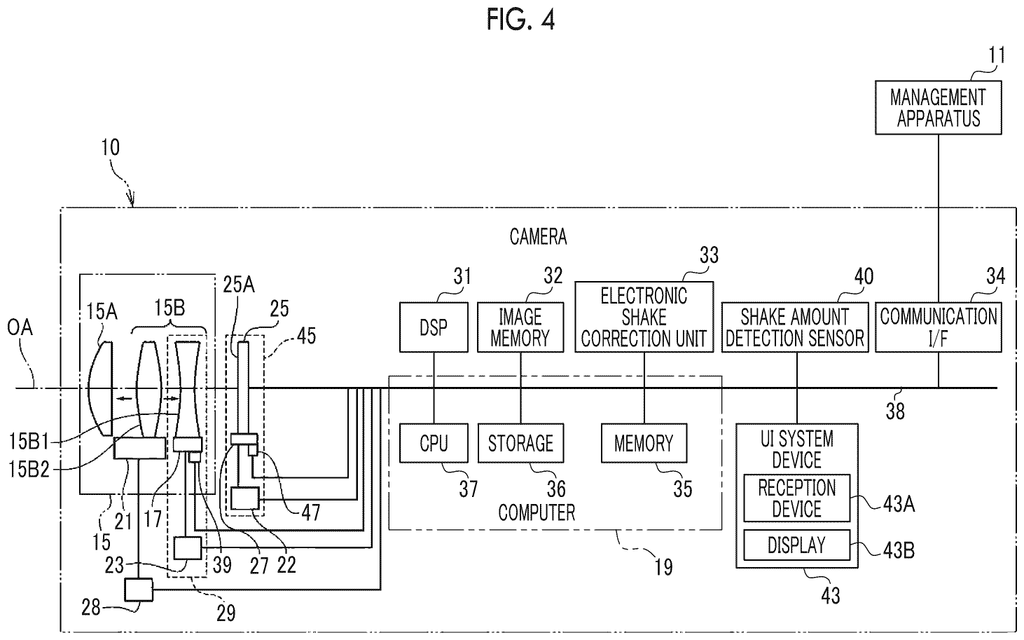

FIG. 4 is a block diagram showing an example of configurations of an optical system and an electrical system of the camera 10. As shown in FIG. 4 as an example, the camera 10 comprises an optical system 15 and an imaging element 25. The imaging element 25 is located in a rear stage of the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not illustrated), a zoom lens 15B2, and the like. The zoom lens 15B2 is movably supported along the optical axis OA by a lens actuator 21 described below. The anti-vibration lens 15B1 is movably supported in a direction orthogonal to the optical axis OA by a lens actuator 17 described below.

An increase in a focal length by the zoom lens 15B2 sets the camera 10 on a telephoto side, and thus an angle of view is decreased (imaging range is narrowed). A decrease in the focal length by the zoom lens 15B2 sets the camera 10 on a wide-angle side, and thus the angle of view is increased (imaging range is widened).

Various lenses (not illustrated) may be provided as the optical system 15 in addition to the objective lens 15A and the lens group 15B. Furthermore, the optical system 15 may comprise a stop. Positions of the lenses, the lens group, and the stop included in the optical system 15 are not limited. For example, the technique of the present disclosure is also effective for positions different from the positions shown in FIG. 4.

The anti-vibration lens 15B1 is movable in a direction perpendicular to the optical axis OA, and the zoom lens 15B2 is movable along the optical axis OA.

The optical system 15 comprises the lens actuators 17 and 21. The lens actuator 17 causes force that fluctuates in a direction perpendicular to an optical axis of the anti-vibration lens 15B1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force that moves along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. With the movement of the position of the zoom lens 15B2 along the optical axis OA, the focal length of the camera 10 changes.

For example, in a case where a contour of the captured image is a rectangle having a short side in the direction of the pitch axis PA and having a long side in the direction of the yaw axis YA, the angle of view in the direction of the pitch axis PA is narrower than the angle of view in the direction of the yaw axis YA and the angle of view of a diagonal line.

With the optical system 15 configured in such a manner, light indicating an imaging target region forms an image on the light-receiving surface 25A of the imaging element 25, and the imaging target region is imaged by the imaging element 25.

By the way, a vibration applied to the camera 10 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Therefore, in the camera 10, shake occurs due to vibration (hereinafter, also simply referred to as “vibration”) applied to the camera 10.

In the present embodiment, the term “shake” refers to a phenomenon, in the camera 10, in which a target subject image on the light-receiving surface 25A of the imaging element 25 fluctuates due to a change in positional relationship between the optical axis OA and the light-receiving surface 25A. In other words, it can be said that the term “shake” is a phenomenon in which an optical image, which is obtained by the image forming on the light-receiving surface 25A, fluctuates due to a tilt of the optical axis OA caused by the vibration applied to the camera 10. The fluctuation of the optical axis OA means that the optical axis OA is tilted with respect to, for example, a reference axis (for example, the optical axis OA before the shake occurs). Hereinafter, the shake that occurs due to the vibration will be also simply referred to as “shake”.

The shake is included in the captured image as a noise component and affects image quality of the captured image. In order to remove the noise component included in the captured image due to the shake, the camera 10 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, the power generated by the driving source such as the motor (for example, voice coil motor) to move the imaging element 25 in the direction perpendicular to the optical axis of the imaging optical system. The electronic shake correction unit 33 performs image processing on the captured image based on a shake amount to correct the shake. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 4 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the method of correcting the shake, a shake correction method is employed in which the anti-vibration lens 15B1 is caused to move based on the shake amount detected by a shake amount detection sensor 40 (described below). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed, but the technique of the present disclosure is not limited thereto. Instead of the voice coil motor, another power source such as a stepping motor or a piezo element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39, but the technique of the present disclosure is not limited thereto. Instead of the Hall element, a magnetic sensor, a photo sensor, or the like may be employed.

The lens-side shake correction mechanism 29 causes the anti-vibration lens 15B1 to move along at least one of the direction of the pitch axis PA or the direction of the yaw axis YA in an actually imaged range to correct the shake. That is, the lens-side shake correction mechanism 29 causes the anti-vibration lens 15B1 to move in the anti-vibration lens two-dimensional plane by a movement amount corresponding to the shake amount to correct the shake.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the method of correcting the shake, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed, but the technique of the present disclosure is not limited thereto. Instead of the voice coil motor, another power source such as a stepping motor or a piezo element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA.

The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47, but the technique of the present disclosure is not limited thereto. Instead of the Hall element, a magnetic sensor, a photo sensor, or the like may be employed.

The camera 10 comprises a computer 19, a digital signal processor (DSP) 31, an image memory 32, the electronic shake correction unit 33, a communication I/F 34, the shake amount detection sensor 40, and a user interface (UI) system device 43. The computer 19 comprises a memory 35, a storage 36, and a central processing unit (CPU) 37.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 4, one bus is illustrated as the bus 38 for convenience of illustration, but a plurality of buses may be used. The bus 38 may be a serial bus or may be a parallel bus such as a data bus, an address bus, and a control bus.

The memory 35 temporarily stores various types of information, and is used as a work memory. A random access memory (RAM) is exemplified as an example of the memory 35, but the embodiment of the present invention is not limited thereto. Another type of storage device may be used. The storage 36 stores various programs for the camera 10. The CPU 37 reads out various programs from the storage 36 and executes the readout various programs on the memory 35 to control the entire camera 10. An example of the storage 36 includes a flash memory, SSD, EEPROM, HDD, or the like. Further, for example, various non-volatile memories such as a magnetoresistive memory and a ferroelectric memory may be used instead of the flash memory or together with the flash memory.

The imaging element 25 is a complementary metal oxide semiconductor (CMOS) type image sensor. The imaging element 25 images a target subject at a predetermined frame rate under an instruction of the CPU 37. The term “predetermined frame rate” described herein refers to, for example, several tens of frames/second to several hundreds of frames/second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not illustrated) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, the photoelectric conversion element having sensitivity to R (red) light (for example, photoelectric conversion element in which an R filter corresponding to R is disposed), the photoelectric conversion element having sensitivity to G (green) light (for example, photoelectric conversion element in which a G filter corresponding to G is disposed), and the photoelectric conversion element having sensitivity to B (blue) light (for example, photoelectric conversion element in which a B filter corresponding to B is disposed) are employed as the plurality of photoelectric conversion elements. In the camera 10, these photosensitive pixels are used to perform the imaging based on the visible light (for example, light on a short wavelength side of about 700 nanometers or less). However, the present embodiment is not limited thereto. The imaging based on infrared light (for example, light on a wavelength side longer than about 700 nanometers) may be performed. In this case, the plurality of photoelectric conversion elements having sensitivity to the infrared light may be used as the plurality of photosensitive pixels. In particular, for example, an InGaAs sensor and/or a simulation of type-II quantum well (T2SL) sensor may be used for short-wavelength infrared (SWIR) imaging.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is exemplified for description as an example of the imaging element 25, but the technique of the present disclosure is not limited thereto. A charge coupled device (CCD) image sensor may be employed as the imaging element 25. In this case, the imaging element 25 is connected to the bus 38 via an analog front end (AFE) (not illustrated) that incorporates a CCD driver. The AFE performs the signal processing, such as the A/D conversion, on the analog imaging signal obtained by the imaging element 25 to generate the digital image and output the generated digital image to the DSP 31. The CCD image sensor is driven by the CCD driver incorporated in the AFE. Of course, the CCD driver may be independently provided.

The DSP 31 performs various types of digital signal processing on the digital image. For example, the various types of digital signal processing refer to demosaicing processing, noise removal processing, gradation correction processing, and color correction processing. The DSP 31 outputs the digital image after the digital signal processing to the image memory 32 for each frame. The image memory 32 stores the digital image from the DSP 31.

The shake amount detection sensor 40 is, for example, a device including a gyro sensor, and detects the shake amount of the camera 10. In other words, the shake amount detection sensor 40 detects the shake amount in each of a pair of axial directions. The gyro sensor detects a rotational shake amount around respective axes (refer to FIG. 1) of the pitch axis PA, the yaw axis YA, and a roll axis RA (axis parallel to the optical axis OA). The shake amount detection sensor 40 converts the rotational shake amount around the pitch axis PA and the rotational shake amount around the yaw axis YA, which are detected by the gyro sensor, into the shake amount in a two-dimensional plane parallel to the pitch axis PA and the yaw axis YA to detect the shake amount of the camera 10.

Here, the gyro sensor is exemplified as an example of the shake amount detection sensor 40, but this is merely an example. The shake amount detection sensor 40 may be an acceleration sensor. The acceleration sensor detects the shake amount in the two-dimensional plane parallel to the pitch axis PA and the yaw axis YA. The shake amount detection sensor 40 outputs the detected shake amount to the CPU 37.

Further, although the form example is described in which the shake amount is detected by a physical sensor called the shake amount detection sensor 40, the technique of the present disclosure is not limited thereto. For example, a movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 performs the image processing on the captured image in the image memory 32 based on the shake amount detected by the shake amount detection sensor 40 to correct the shake.

Here, the device including the ASIC is exemplified as the electronic shake correction unit 33, but the technique of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and controls transmission of various types of information to and from the management apparatus 11 via a network. The network is, for example, a wide area network (WAN) or a local area network (LAN), such as the Internet. The communication I/F 34 performs communication between the camera 10 and the management apparatus 11.

The UI system device 43 comprises a reception device 43A and a display 43B. The reception device 43A is, for example, a hard key, a touch panel, and the like, and receives various instructions from a user. The CPU 37 acquires various instructions received by the reception device 43A and operates in response to the acquired instructions.

The display 43B displays various types of information under the control of the CPU 37. Examples of the various types of information displayed on the display 43B include a content of various instructions received by the reception device 43A and the captured image.

### <Configuration of Electrical System of Revolution Mechanism 16 and Management Apparatus 11>

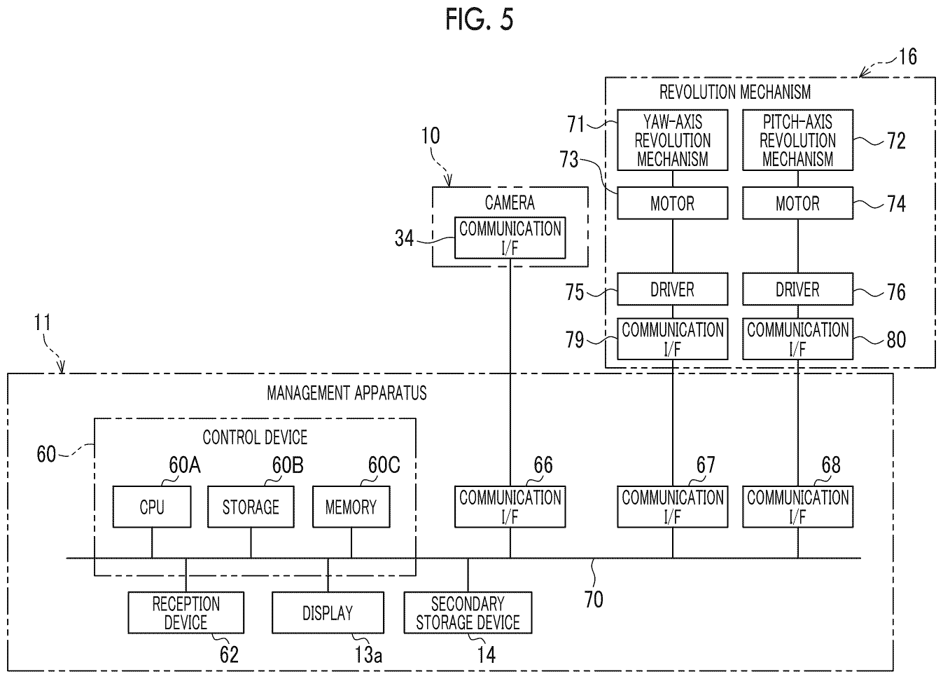

FIG. 5 is a diagram showing an example of a configuration of an electrical system of the revolution mechanism 16 and the management apparatus 11. As shown in FIG. 5 as an example, the revolution mechanism 16 comprises a yaw-axis revolution mechanism 71, a pitch-axis revolution mechanism 72, motors 73 and 74, drivers 75 and 76, and communication I/Fs 79 and 80.

The yaw-axis revolution mechanism 71 causes the camera 10 to revolve in the yaw direction. The motor 73 is driven to generate the power under the control of the driver 75. The yaw-axis revolution mechanism 71 receives the power generated by the motor 73 to cause the camera 10 to revolve in the yaw direction. The pitch-axis revolution mechanism 72 causes the camera 10 to revolve in the pitch direction. The motor 74 is driven to generate the power under the control of the driver 76. The pitch-axis revolution mechanism 72 receives the power generated by the motor 74 to cause the camera 10 to revolve in the pitch direction.

The communication I/Fs 79 and 80 are, for example, network interfaces, and control transmission of various types of information to and from the management apparatus 11 via the network. The network is, for example, a WAN or a LAN, such as the Internet. The communication I/Fs 79 and 80 performs communication between the revolution mechanism 16 and the management apparatus 11.

As shown in FIG. 5 as an example, the management apparatus 11 comprises the display 13a, the secondary storage device 14, a control device 60, a reception device 62, and communication I/Fs 66, 67, and 68. The control device 60 comprises a CPU 60A, a storage 60B, and a memory 60C. The CPU 60A is an example of the processor according to the embodiment of the present invention. The memory 60C is an example of a storage device according to the embodiment of the present invention.

Each of the reception device 62, the display 13a, the secondary storage device 14, the CPU 60A, the storage 60B, the memory 60C, and the communication I/F 66 is connected to a bus 70. In the example shown in FIG. 5, one bus is illustrated as the bus 70 for convenience of illustration, but a plurality of buses may be used. The bus 70 may be a serial bus or may be a parallel bus including a data bus, an address bus, a control bus, and the like.

The memory 60C temporarily stores various types of information and is used as the work memory. An example of the memory 60C includes the RAM, but the embodiment of the present invention is not limited thereto. Another type of storage device may be employed. Various programs for the management apparatus 11 (hereinafter, simply referred to as “programs for management apparatus”) are stored in the storage 60B.

The CPU 60A reads out the program for the management apparatus from the storage 60B and executes the readout program for the management apparatus on the memory 60C to control the entire management apparatus 11. The program for the management apparatus includes an information processing program according to the embodiment of the present invention.

The communication I/F 66 is, for example, a network interface. The communication I/F 66 is communicably connected to the communication I/F 34 of the camera 10 via the network, and controls transmission of various types of information to and from the camera 10. The communication I/Fs 67 and 68 are, for example, network interfaces. The communication I/F 67 is communicably connected to the communication I/F 79 of the revolution mechanism 16 via the network, and controls transmission of various types of information to and from the yaw-axis revolution mechanism 71. The communication I/F 68 is communicably connected to the communication I/F 80 of the revolution mechanism 16 via the network, and controls transmission of various types of information to and from the pitch-axis revolution mechanism 72.

The CPU 60A receives the captured image, the imaging information, and the like from the camera 10 via the communication I/F 66 and the communication I/F 34. The CPU 60A controls the imaging operation of the imaging target by the camera 10 via the communication I/F 66 and the communication I/F 34.

The CPU 60A controls the driver 75 and the motor 73 of the revolution mechanism 16 via the communication I/F 67 and the communication I/F 79 to control a revolution operation of the yaw-axis revolution mechanism 71. Further, the CPU 60A controls the driver 76 and the motor 74 of the revolution mechanism 16 via the communication I/F 68 and the communication I/F 80 to control the revolution operation of the pitch-axis revolution mechanism 72.

The CPU 60A acquires the imaging information at the discrete positions of the first subject, which is the imaging target of the camera 10, and the subject information related to the first subject. The first subject is, for example, a linear structure in which the subject does not fit entirely within the set angle of view. The first subject includes, for example, a power transmission line, a suspension cable of a suspension bridge, a cable of a ropeway, a cable of a ski resort lift, and the like.

The discrete positions of the first subject are, for example, a plurality of positions on a power transmission line selected from power transmission lines connected between steel towers, and are a plurality of positions having an interval therebetween. Specifically, the discrete positions are at least three adjacent points among a plurality of points automatically extracted based on the image analysis of the first subject. The discrete positions may be three points obtained by combining two points located in an end region of the first subject and one point different from the two points at the end among the plurality of points extracted by the image analysis of the first subject. The discrete positions are calculated based on an analysis result of, for example, a wide-angle image obtained by imaging the first subject. The discrete positions may be a plurality of points designated by the user.

The imaging information includes, for example, a control value based on an angle of view of the camera 10 for imaging the discrete positions. In addition, the imaging information includes, for example, a control value of the revolution mechanism 16 for imaging the discrete positions. The control value of the revolution mechanism 16 is, for example, a pan/tilt value for controlling the imaging direction of the camera 10. In addition, the imaging information includes, for example, a control value based on a distance between the first subject and the camera 10 for imaging the discrete positions. In addition, the imaging information includes, for example, a control value of the camera 10 for imaging the discrete positions. The control value of the camera 10 is, for example, a focus position of the camera 10. In a case where the focus position is acquired by image analysis, the focus position is acquired based on, for example, the number of pixels of the subject in the images at a plurality of automatically extracted positions (points). In addition, in a case where the user designates the plurality of positions (points), the focus position is acquired by the user aligning the orientation of the camera with the designated position and pressing the autofocus button.

The focus position of the camera 10 is acquired by performing distance measurement in a state where the zoom lens 15B2 is set to the telephoto region. In a case where the focus position is acquired by the image analysis, the zoom adjustment of the zoom lens 15B2 is automatically adjusted to the telephoto region. In a case where the user presses the autofocus button to acquire the focus position, the user is notified to adjust the zoom lens 15B2 to the telephoto region before pressing the autofocus button.

The subject information related to the first subject is a suspension line shape of a power transmission line connected between steel towers. The subject information is a shape in a two-dimensional plane of an angle of view for imaging the first subject. The subject information may be information given in advance, information determined by the image analysis, or information set by the user.

The CPU 60A sets a first imaging path, which is an imaging path of the first subject, based on the imaging information and the subject information. The CPU 60A controls the imaging operation of the first subject by the camera 10 based on the set first imaging path. The first imaging path includes, for example, a control value for dividing and imaging the first subject. The control value for dividing and imaging is a control value in which a plurality of sets of a pan/tilt value for controlling the imaging direction of the camera 10 by the revolution mechanism 16 and a focus position of the camera 10 are included.

The CPU 60A controls the imaging operation of the second subject, which is the imaging target of the camera 10, based on the information of the first subject. The second subject is, for example, a power transmission line different from the first subject. Specifically, the second subject is a second power transmission line that is different from a first power transmission line in a plurality of power transmission lines connected between the steel towers.

The CPU 60A acquires the imaging information (pan/tilt value, focus position, and the like) at the first position in the first subject and the imaging information (pan/tilt value, focus position, and the like) at the second position in the second subject. The first position is a position in a region of the first subject close to the camera 10. The second position is a position in a region of the second subject close to the camera 10. The first subject is a subject that is present at a position closer to the camera 10 than the second subject. The CPU 60A acquires difference information between the imaging information at the first position in the first subject and the imaging information at the second position in the second subject. The CPU 60A sets a second imaging path, which is an imaging path of the second subject, based on the first imaging path of the first subject and difference information between the first position of the first subject and the second position of the second subject. The CPU 60A controls the imaging operation of the second subject by the camera 10 based on the set second imaging path.

In a case where it is determined that the entirety of the second subject cannot be imaged within the movable range of the revolution mechanism 16 in a case of imaging the second subject in the second imaging path of the second subject, the CPU 60A calculates the installation position of the revolution mechanism 16 with respect to the second subject of which the entirety can be imaged in the second imaging path. The CPU 60A outputs the calculated installation position of the revolution mechanism 16, for example, to the display 13a of the management apparatus 11 as the notification information.

The CPU 60A generates a composite image obtained by combining a plurality of captured images of the first subject obtained by imaging with the camera 10 in the first imaging path and a plurality of captured images of the second subject obtained by imaging with the camera 10 in the second imaging path, and outputs the generated composite image to the display 13a. The CPU 60A generates a composite image in which a subject closer to the camera 10 between the first subject and the second subject is seen in front of a subject farther from the camera 10 between the first subject and the second subject, based on the distance information between the first subject and the camera 10 and the distance information between the second subject and the camera 10.

In the control of the imaging of the first subject based on the first imaging path, the CPU 60A changes the zoom amount of the zoom lens 15B2 according to the information on the imaging distance from the camera 10 to the first subject in the first imaging path. The information on the imaging distance includes information on the distance measurement result between the camera 10 and the first subject, information on the focus position of the camera 10 based on the distance measurement result, and the like. The zoom amount is an amount corresponding to the set resolution.

The CPU 60A stores information related to the imaging angle of the first subject based on the first imaging path in the memory 60C or the secondary storage device 14 in association with the first subject.

The CPU 60A generates a composite image obtained by combining a plurality of captured images of the first subject obtained by imaging with the camera 10 in the first imaging path and a plurality of captured images of the second subject obtained by imaging with the camera 10 in the second imaging path, and outputs the generated composite image to the display 13a. The CPU 60A receives designation of a position in the composite image and outputs the captured image corresponding to the designated position to the display 13a. The display on which the composite image is displayed and the display on which the designated captured image is displayed may be different displays.

The CPU 60A stores, in the memory 60C or the secondary storage device 14, information related to a plurality of times of imaging of the first subject controlled in a state where the camera 10 is installed at different locations in association with the first subject.

The reception device 62 is, for example, the keyboard 13b, the mouse 13c, and a touch panel of the display 13a, and receives various instructions from the user. The CPU 60A acquires various instructions received by the reception device 62 and operates in response to the acquired instructions. For example, in a case where the reception device 62 receives a processing content for the camera 10 and/or the revolution mechanism 16, the CPU 60A causes the camera 10 and/or the revolution mechanism 16 to operate in accordance with an instruction content received by the reception device 62.

The display 13a displays various types of information under the control of the CPU 60A. Examples of the various types of information displayed on the display 13a include contents of various instructions received by the reception device 62 and the captured image or imaging information received by the communication I/F 66. The CPU 60A causes the display 13a to display the contents of various instructions received by the reception device 62 and the captured image or imaging information received by the communication I/F 66.

The secondary storage device 14 is, for example, a non-volatile memory and stores various types of information under the control of the CPU 60A. An example of the various types of information stored in the secondary storage device 14 includes the captured image or imaging information received by the communication I/F 66. The CPU 60A stores the captured image or imaging information received by the communication I/F 66 in the secondary storage device 14.

### <Imaging Processing by CPU 60A of Control Device 60>

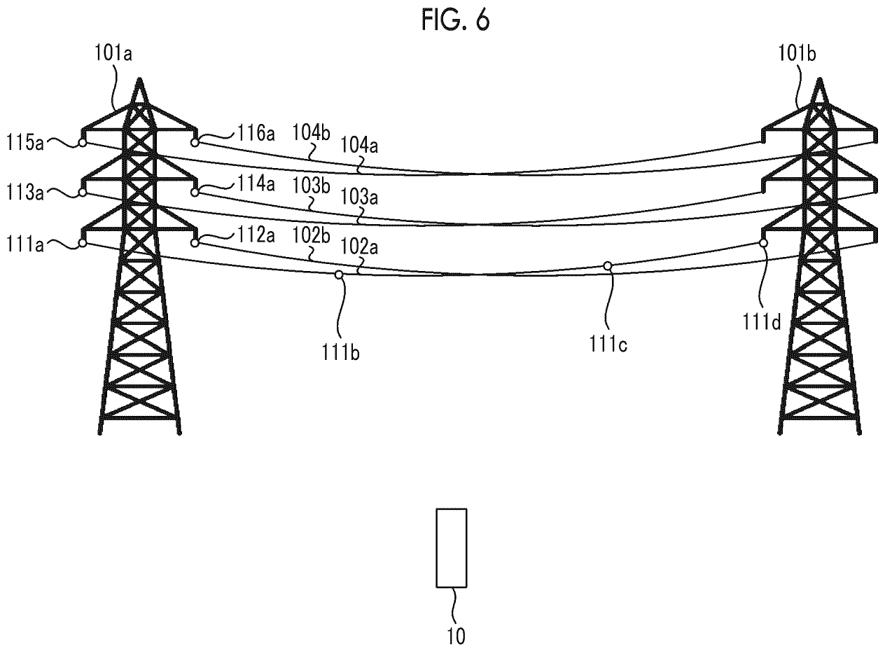

FIG. 6 is a diagram showing an example in which a power transmission line 102 connected between steel towers 101a and 101b is inspected using the camera 10. In the example shown in FIG. 6, two rows and three stages (total six) of power transmission lines 102a, 102b, 103a, 103b, 104a, and 104b are connected between the adjacent steel towers 101a and 101b.

In a case where there are a plurality of imaging targets as described above and the imaging targets are in a similar configuration, the imaging information for imaging the predetermined imaging target (in the present example, the power transmission line) selected first is acquired, and the imaging information of the second and subsequent power transmission lines is calculated using the acquired imaging information related to the first imaging target.

For example, in the plurality of power transmission lines shown in FIG. 6, the power transmission line 102a is selected as the first imaging target, and the imaging information of the power transmission line 102a is acquired. Then, the imaging information of the other second and subsequent power transmission lines 102b, 103a, 103b, 104a, and 104b is calculated based on the positional relationship with the power transmission line 102a.

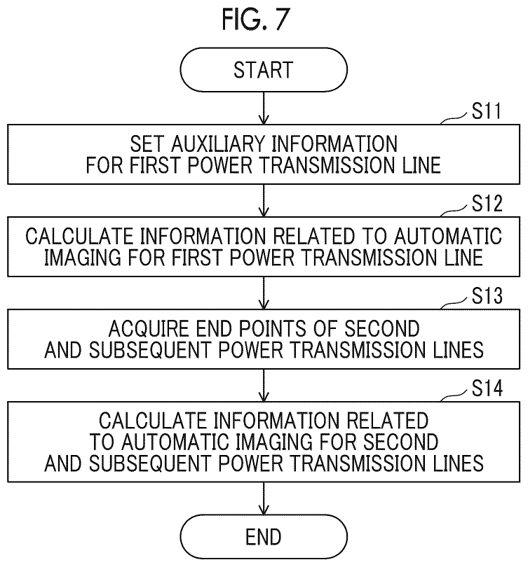

FIG. 7 is a flowchart showing an example of imaging processing of the imaging target by the CPU 60A of the control device 60. In the present example, a case where the power transmission lines 102a, 102b, 103a, 103b, 104a, and 104b between the steel towers 101a and 101b shown in FIG. 6 are imaged and inspected using the camera 10 will be described.

The camera 10 is installed toward an imaging target, and a zoom position of a zoom lens is set to a wide-angle end. Data of the wide-angle image captured by the camera 10 is transmitted to the management apparatus 11 via the communication line 12.

A worker (user) is present in front of the management apparatus 11 and is viewing the captured image of the camera 10 displayed on the display 13a. The worker performs the inspection work while operating the camera 10 via the communication line 12 by operating the keyboard 13b or the mouse 13c of the management apparatus 11 or performing a touch operation on the display 13a.

The CPU 60A of the management apparatus 11 starts the processing shown in FIG. 7 in response to the designation operation of the imaging target from the worker in a state where the wide-angle image is displayed on the display 13a.

The CPU 60A sets auxiliary information that is auxiliary information for imaging the first power transmission line which is the first imaging target (step S11). The auxiliary information is the pan/tilt value of the revolution mechanism 16 and the focus position of the camera 10 at a plurality of positions (points) on the power transmission line. The auxiliary information is set by, for example, the worker designating a plurality of positions (points) on the power transmission line.

Specifically, as shown in FIG. 6, the power transmission line 102a on the lower front side of the two-row and three-stage power transmission lines is selected as the first power transmission line. In the selected power transmission line 102a, for example, a plurality of positions 111a to 111d having an interval therebetween are selected by the worker. As a result, the auxiliary information at the plurality of selected positions 111a to 111d is set. The first power transmission line, which is the first imaging target, is selected as the power transmission line closest to the camera 10. The power transmission line 102a is an example of the first subject according to the embodiment of the present invention. The setting of the auxiliary information may be setting based on extraction of a plurality of points by image analysis, instead of setting by selection of the worker.

Next, the CPU 60A calculates automatic imaging information for automatically imaging the entire first power transmission line 102a based on the auxiliary information set in step S11 and known information that the shape of the power transmission line is a suspension line (step S12). The automatic imaging information is, for example, curve information of the power transmission line 102a. The automatic imaging information may be a plurality of pieces of continuous position information (pan/tilt value, focus position) or the like on a curve of the power transmission line 102a. The calculated automatic imaging information is the first imaging path of the power transmission line 102a which is the first subject.

Next, the CPU 60A acquires information on the end points in the second and subsequent power transmission lines (step S13). The information on the end point is input by, for example, a designation operation from the worker. The worker designates the end points of the second and subsequent power transmission lines in the wide-angle image displayed on the display 13a by a touch operation or the like. The information on the end point is a pan/tilt value of the revolution mechanism 16, a focus position of the camera 10, and the like. The information on the end points may be detected by image analysis.

Specifically, as shown in FIG. 6, information on an end point 112a of the power transmission line 102b, information on an end point 113a of the power transmission line 103a, information on an end point 114a of the power transmission line 103b, information on an end point 115a of the power transmission line 104a, and information on an end point 116a of the power transmission line 104b, the power transmission lines 102b, 103a, 103b, 104a, and 104b being the second and subsequent power transmission lines, are acquired.

Next, the CPU 60A calculates the automatic imaging information for automatically imaging each of the second and subsequent power transmission line 102b to the power transmission line 104b from one end to the other end based on the information acquired in step S11 to step S13 (step S14). For example, the CPU 60A compares the information related to the first power transmission line 102a acquired in steps S11 and S12 with the information related to the end points 112a, 113a, 114a, 115a, and 116a of the second and subsequent power transmission lines 102b, 103a, 103b, 104a, and 104b acquired in step S13 to calculate the difference information. The CPU 60A calculates the automatic imaging information of the second and subsequent power transmission lines 102b, 103a, 103b, 104a, and 104b based on the calculated difference information. The automatic imaging information is, for example, the curve information of the power transmission lines 102b, 103a, 103b, 104a, and 104b, and is the second imaging path of the power transmission lines 102b, 103a, 103b, 104a, and 104b which are the second subjects.

The CPU 60A automatically images the power transmission lines 102a, 102b, 103a, 103b, 104a, and 104b based on the automatic imaging information calculated in steps S12 and S14. The automatic imaging of the power transmission lines 102a, 102b, 103a, 103b, 104a, and 104b may be performed each time the automatic imaging information of each power transmission line is calculated, or the automatic imaging may be performed after the automatic imaging information of all the power transmission lines is calculated.

### <Example of Automatic Imaging of First Power Transmission Line>

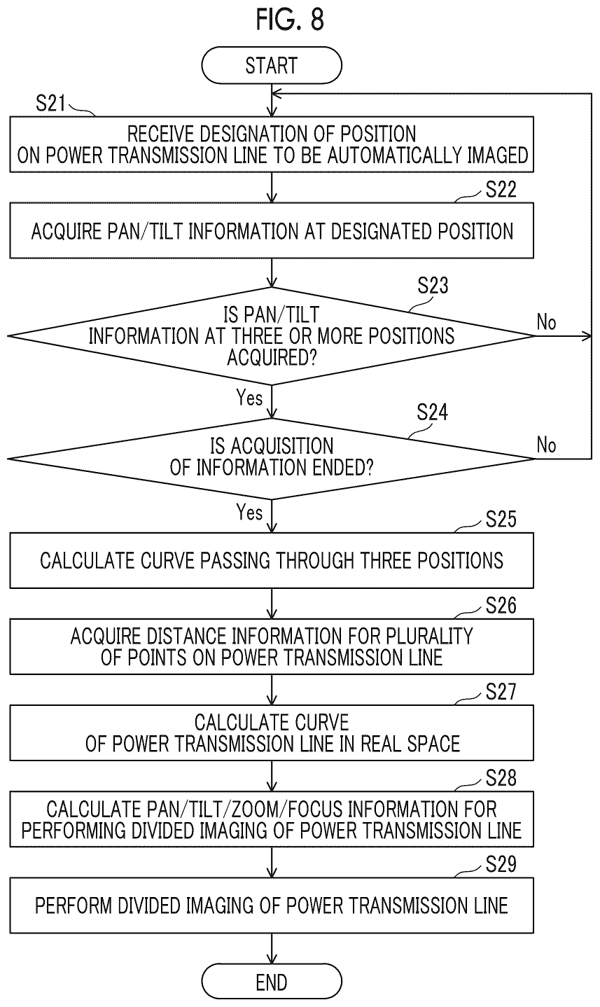

FIG. 8 is a flowchart showing an example of automatic imaging for the first power transmission line which is the first imaging target. The automatic imaging in the present example is automatic imaging executed based on the auxiliary information of the power transmission line set by the worker.

In a state where the wide-angle image of the power transmission line as the imaging target is displayed on the display 13a, the CPU 60A of the management apparatus 11 starts the processing shown in FIG. 8 in a case where any position (point) on the power transmission line is selected by, for example, a click operation or a touch operation from the worker with respect to the first power transmission line. Specifically, in FIG. 6, in a case where the positions 111a to 111d on the power transmission line 102a are selected, the CPU 60A starts the processing.

The CPU 60A receives designation of the position on the first power transmission line 102a selected by the worker (step S21).

Next, the CPU 60A acquires the information on the pan/tilt value at the position on the power transmission line 102a designated in step S21 (step S22). For example, the CPU 60A can calculate a relationship between each coordinate on the power transmission line 102a in the wide-angle image displayed on the display 13a and the pan/tilt value based on the size and the positional relationship of the wide-angle image and the power transmission line 102a. The calculated pan/tilt value is stored in the memory 60C or the secondary storage device 14 as correspondence information in association with each coordinate of the power transmission line 102a. The CPU 60A acquires the pan/tilt value corresponding to the position on the designated power transmission line 102a based on the correspondence information calculated in advance.

Next, the CPU 60A determines whether or not the information on the pan/tilt values at three or more positions on the power transmission line 102a is acquired (step S23).

In step S23, in a case where the information on the pan/tilt values at three or more positions is not acquired (step S23: No), the CPU 60A returns to step S21 and repeats each processing. In step S23, in a case where the information on the pan/tilt values at three or more positions is acquired (step S23: Yes), the CPU 60A determines whether or not the acquisition of the information on the pan/tilt values at the positions on the power transmission line 102a is ended (step S24). For example, the CPU 60A determines whether to end the acquisition of the information based on whether or not an end operation indicating that the selection of the position designation by the worker is ended is received.

Next, the CPU 60A calculates a curve passing through three positions among the positions at which the information on the pan/tilt value is acquired (step S25). The three positions are three points in a case where three positions are designated, and are three adjacent points or points at both ends and any other point in a case where four or more points are acquired. The curve is a suspension line that is a shape of the power transmission line 102a. However, the curve may be a curve such as a quadratic curve.

Next, the CPU 60A acquires distance information for a plurality of points on the power transmission line 102a (step S26). The distance from the camera 10 to the point on the power transmission line 102a can be estimated from the information on the focus position of the point on the power transmission line 102a. Therefore, for example, the worker performs focusing at the plurality of points on the power transmission line 102a, and thus, distance information between the plurality of points is acquired from the information on the focus position. The plurality of points on the power transmission line 102a may be points that are randomly selected by the worker. The focusing is performed in a state where the zoom lens 15B2 is set to the telephoto end.

Next, the CPU 60A calculates the curve of the power transmission line 102a in the real space based on the curve calculated in step S25 and the distance information acquired in step S26 (step S27).

Next, the CPU 60A calculates information on the pan, the tilt, the zoom, and the focus for dividing and imaging the power transmission line 102a (step S28). Specifically, the CPU 60A calculates the information on the pan, the tilt, the zoom, and the focus at the position at each predetermined interval on the curve of the power transmission line 102a calculated in step S27. The information obtained by combining the information on the pan, the tilt, the zoom, and the focus on the calculated curve of the power transmission line 102a is the first imaging path of the power transmission line 102a which is the first subject.

The CPU 60A performs the divided imaging of the power transmission line 102a based on the first imaging path calculated in step S28 (step S29).

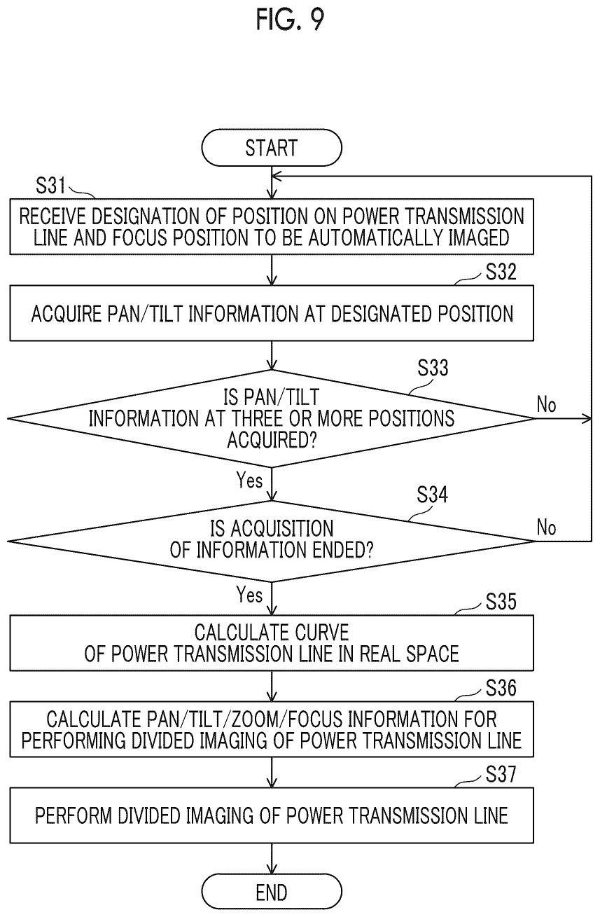

FIG. 9 is a flowchart showing another example of the automatic imaging executed based on the auxiliary information of the power transmission line set by the worker. The fact that the present processing is started by the worker selecting the positions 111a to 111d on the power transmission line 102a in FIG. 6 is the same as the processing in FIG. 8.

The CPU 60A receives the designation of the position on the selected first power transmission line 102a and the focus position (step S31). In a case where the designation of the focus position is received, the distance information is acquired based on the autofocus. The fact that the distance information of the point on the power transmission line 102a is acquired in step S31 in the processing of the present example is different from the processing in FIG. 8 in that the distance information is acquired after the acquisition of the information on the pan/tilt value is ended.

Since each processing from step S32 to step S34 is the same as each processing from step S22 to step S24 in FIG. 8, the description thereof will be omitted.

Next, the CPU 60A calculates the curve of the power transmission line 102a in the real space based on the distance information acquired in step S31 and the information on the pan/tilt value acquired in step S32 (step S35).

Since the processing of step S36 to step S37 is the same as the processing of step S28 to step S29 in FIG. 8, the description thereof will be omitted.

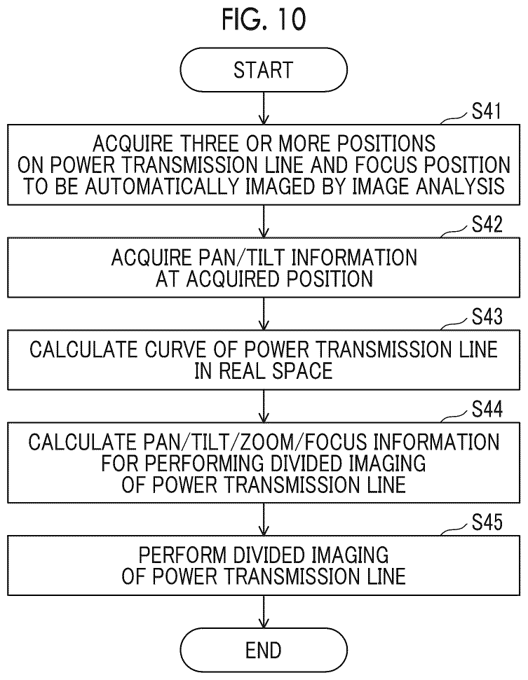

FIG. 10 is a flowchart showing an example of the automatic imaging executed based on the auxiliary information of the power transmission line set by the image analysis. The present processing is started in a state where a wide-angle image of the power transmission line as the imaging target is displayed on the display 13a, for example, in a case where an image analysis imaging button (not illustrated) is touched.

In a case where the image analysis imaging button is touched, the CPU 60A acquires three or more positions on the power transmission line 102a and the focus position by the image analysis (step S41). In a case of the image analysis, three or more positions are automatically extracted. In addition, the focus position of the three or more extracted positions is automatically acquired.

Next, the CPU 60A acquires the information on the pan/tilt value at the position on the power transmission line 102a acquired in step S41 (step S42). The acquisition of the information on the pan/tilt value is the same as the processing of step S22 in FIG. 8.

Next, the CPU 60A calculates the curve of the power transmission line 102a in the real space based on the distance information based on the focus position acquired in step S41 and the information on the pan/tilt value acquired in step S42 (step S43).

Since the processing of step S44 to step S45 is the same as the processing of step S28 to step S29 in FIG. 8, the description thereof will be omitted.

### <Example of Automatic Imaging of Second and Subsequent Power Transmission Lines>

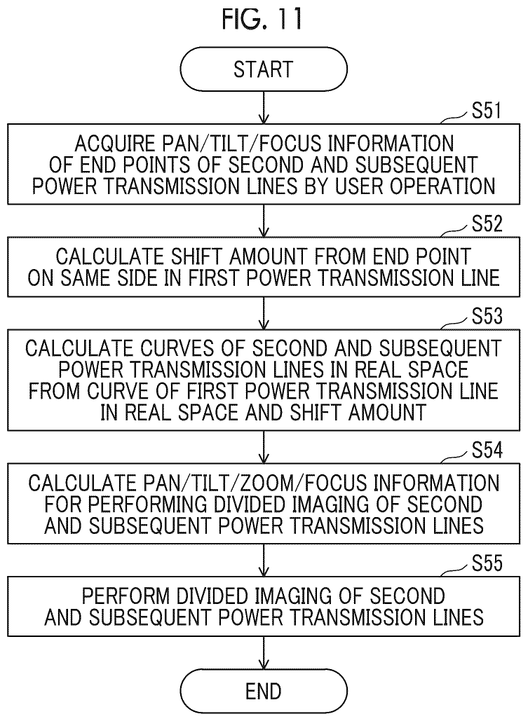

FIG. 11 is a flowchart showing an example of automatic imaging for the second and subsequent power transmission lines which are the next imaging targets of the power transmission line 102a. The automatic imaging in the present example is automatic imaging executed based on the auxiliary information of the power transmission line set by the worker.

In a state where the wide-angle image of the power transmission line as the imaging target is displayed on the display 13a, the CPU 60A of the management apparatus 11 starts the processing shown in FIG. 11 in a case where the end point of the power transmission line is designated by, for example, a click operation or a touch operation from the worker with respect to the second and subsequent power transmission lines. Specifically, in FIG. 6, the CPU 60A starts the processing in a case where the end point 112a of the power transmission line 102b, the end point 113a of the power transmission line 103a, the end point 114a of the power transmission line 103b, the end point 115a of the power transmission line 104a, and the end point 116a of the power transmission line 104b (hereinafter, also referred to as the end points 112a, 113a, 114a, 115a, and 116a of the power transmission lines 102b, 103a, 103b, 104a, and 104b) are designated.

The CPU 60A acquires the information on the pan, the tilt, and the focus of the end points 112a, 113a, 114a, 115a, and 116a of the second and subsequent power transmission lines 102b, 103a, 103b, 104a, and 104b designated by the worker (step S51). The end point of the power transmission line referred to here is an end point on the side close to the camera 10 in each power transmission line.

Next, the CPU 60A compares the information on the pan, the tilt, and the focus of the end points 112a, 113a, 114a, 115a, and 116a of the power transmission lines 102b, 103a, 103b, 104a, and 104b acquired in step S51 with the information on the pan, the tilt, and the focus of the end point on the same side in the first power transmission line 102a, and calculates the shift amount from the first power transmission line 102a, which is the difference information, respectively (step S52).

Next, the CPU 60A calculates the curves of the second and subsequent power transmission lines 102b, 103a, 103b, 104a, and 104b in the real space based on the curve of the first power transmission line 102a in the real space and the shift amount calculated in step S52 (step S53). Instead of calculating the curves of the power transmission lines 102b, 103a, 103b, 104a, and 104b in the real space, for example, the information on the pan, the tilt, and the focus for the divided imaging of the second and subsequent power transmission lines 102b, 103a, 103b, 104a, and 104b may be calculated by applying the shift amount to the information on the pan, the tilt, and the focus for the divided imaging of the first power transmission line 102a. That is, the imaging path may be shifted.

Next, the CPU 60A calculates the information on the pan, the tilt, the zoom, and the focus for dividing and imaging the power transmission lines 102b, 103a, 103b, 104a, and 104b (step S54). Specifically, the CPU 60A calculates the information on the pan, the tilt, the zoom, and the focus at the position at each predetermined interval on the curve of the power transmission lines 102b, 103a, 103b, 104a, and 104b calculated in step S53. The information obtained by combining the information on the pan, the tilt, the zoom, and the focus on the calculated curves of the power transmission lines 102b, 103a, 103b, 104a, and 104b is the second imaging path of the power transmission lines 102b, 103a, 103b, 104a, and 104b which are the second subject.

The CPU 60A performs the divided imaging of the power transmission lines 102b, 103a, 103b, 104a, and 104b based on the second imaging path calculated in step S54 (step S55).

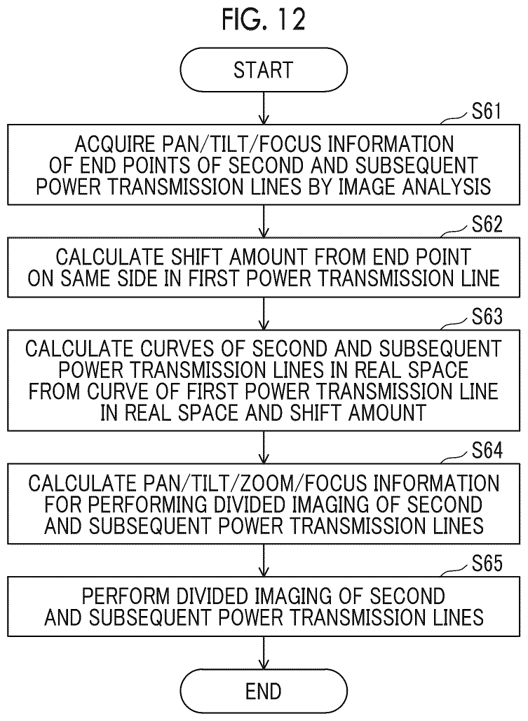

FIG. 12 is a flowchart showing an example of the automatic imaging executed based on the auxiliary information of the power transmission line set by the image analysis. The present processing is started in a state where a wide-angle image of the power transmission line as the imaging target is displayed on the display 13a, for example, in a case where an image analysis imaging button (not illustrated) is touched.

In a case where the image analysis imaging button is touched, the CPU 60A acquires the information on the pan, the tilt, and the focus of the end points 112a, 113a, 114a, 115a, and 116a of the second and subsequent power transmission lines 102b, 103a, 103b, 104a, and 104b by the image analysis (step S61). In a case of the image analysis, the positions of the end points are automatically extracted. In addition, the focus information of the extracted end points is automatically acquired. The end point of the power transmission line is an end point on the side close to the camera 10 in each power transmission line.

Since each processing from step S62 to step S65 is the same as each processing from step S52 to step S55 in FIG. 11, the description thereof will be omitted.

As described above, the CPU 60A provided in the control device 60 sets the imaging path of the power transmission line 102a based on the imaging information at the discrete positions 111a to 111d on the power transmission line 102a and the subject information related to the suspension line shape of the power transmission line 102a, and controls the imaging of the power transmission line 102a based on the set imaging path.

With this configuration, it is possible to set the imaging path for imaging the power transmission line 102a by using the information of the suspension line shape, which is the known information of the power transmission line 102a, only by designating the plurality of points on the power transmission line 102a. Therefore, the power transmission line 102a can be efficiently divided and imaged based on the set imaging path.

In addition, the CPU 60A acquires difference information between the imaging information of the end point (position 111a) of the power transmission line 102a and the imaging information of the end points 112a, 113a, 114a, 115a, and 116a of the second and subsequent power transmission lines 102b, 103a, 103b, 104a, and 104b, sets the imaging paths of the second and subsequent power transmission lines 102b, 103a, 103b, 104a, and 104b based on the imaging path of the power transmission line 102a and the difference information, and controls the imaging of the second and subsequent power transmission lines 102b, 103a, 103b, 104a, and 104b based on the set imaging path.

With this configuration, it is possible to set the imaging paths of the second and subsequent power transmission lines 102b, 103a, 103b, 104a, and 104b based on the imaging path of the first power transmission line 102a only by designating the end points 112a, 113a, 114a, 115a, and 116a of the second and subsequent power transmission lines 102b, 103a, 103b, 104a, and 104b. Therefore, the second and subsequent power transmission lines 102b, 103a, 103b, 104a, and 104b can be efficiently divided and imaged based on the set imaging path.

In addition, the CPU 60A can automatically extract a plurality of positions on the power transmission line 102a and automatically acquire the focus position by image analysis. In addition, the CPU 60A can extract the end points of the second and subsequent power transmission lines 102b, 103a, 103b, 104a, and 104b and automatically acquire the focus position of the end points by image analysis. Therefore, it is possible to easily set the imaging path of the power transmission line 102a and the imaging paths of the second and subsequent power transmission lines 102b, 103a, 103b, 104a, and 104b, and the power transmission lines 102a and the second and subsequent power transmission lines 102b, 103a, 103b, 104a, and 104b can be efficiently divided and imaged.

In addition, the CPU 60A acquires the focus position of the camera 10 by causing the camera 10 to execute the distance measurement in a state where the zoom lens 15B2 is set to the telephoto region. By setting the zoom lens 15B2 to the telephoto region during the distance measurement, the distance measurement accuracy of the camera 10 can be enhanced.

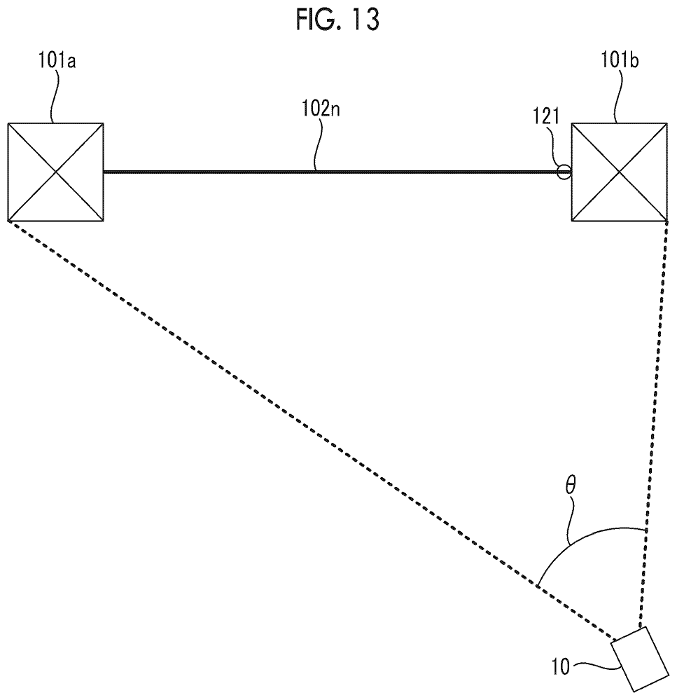

FIG. 13 is a diagram showing an end part of a power transmission line designated in a case where the second and subsequent power transmission lines are automatically imaged. As shown in FIG. 13, it is assumed that the camera 10 is set such that the second and subsequent power transmission lines 102n, which are the imaging targets, are included within the range of the angle of view θ that can be imaged by the camera 10. The power transmission lines 102n are connected between the steel towers 101a and 101b. In a case of the positional relationship between the camera 10 and the steel towers 101a and 101b in the present example, the distance from the camera 10 to the steel tower 101b is shorter than the distance from the camera 10 to the steel tower 101a.

In such a case, in a case of automatically imaging the power transmission lines 102n, for example, the end part 121 of the power transmission lines 102n on the steel tower 101b side close to the camera 10 is designated. The distance information of the subject can be converted from the focus information, but the accuracy of the distance information is higher as the distance from the camera to the subject is shorter.

Therefore, in a case of automatically imaging the second and subsequent power transmission lines 102n, by designating the end part 121 on the steel tower 101b side close to the camera 10, the shift amount of the second and subsequent power transmission lines 102n with respect to the first power transmission line can be accurately calculated. Accordingly, it is possible to improve the focus accuracy in a case of the automatic imaging of the second and subsequent power transmission lines 102n.

### <Selection of First Power Transmission Line>

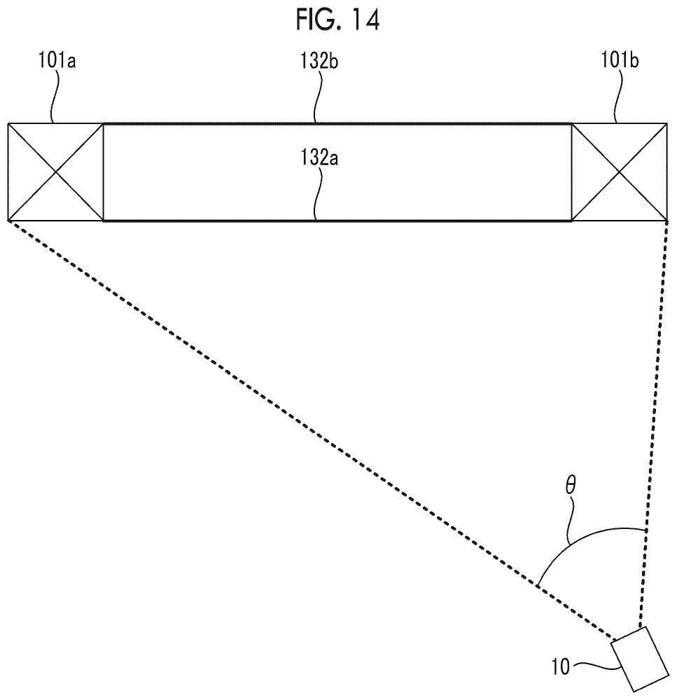

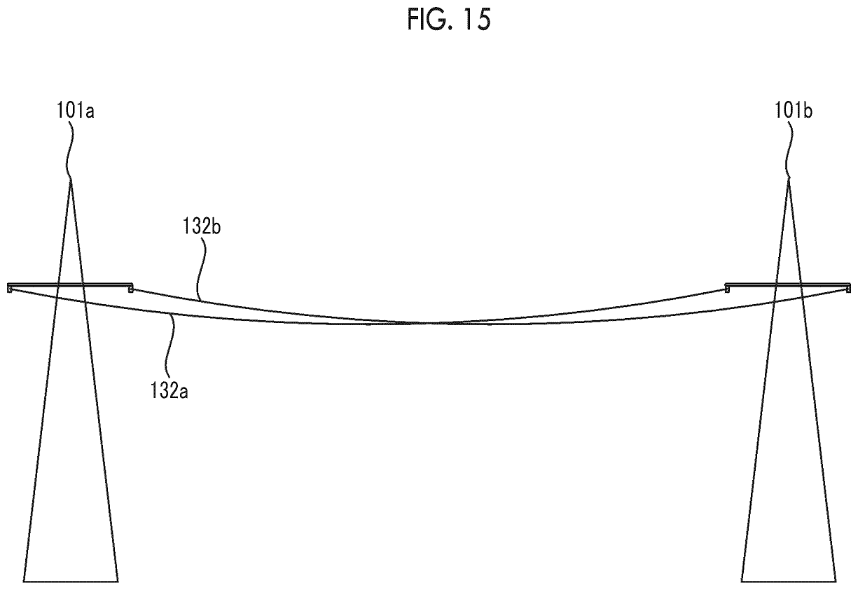

FIG. 14 is a diagram in which power transmission lines 132a and 132b connected between the steel towers 101a and 101b and the camera 10 that images the power transmission lines 132a and 132b are viewed from above. FIG. 15 is a diagram in which the steel towers 101a and 101b and the power transmission lines 132a and 132b shown in FIG. 14 are viewed from a camera 10 side. As shown in FIGS. 14 and 15, it is assumed that the power transmission lines 132a and 132b are connected in parallel at positions at approximately the same height as the steel towers 101a and 101b. In this case, as shown in FIG. 15, the power transmission lines 132a and 132b may be seen to intersect each other at an intermediate position between the steel towers 101a and 101b as viewed from the camera 10 side.

As described in the above-described embodiment, it is necessary to acquire information on the pan, the tilt, and the focus at the plurality of positions in the first power transmission line (first subject) in order to perform the automatic imaging. Therefore, in the cases of the power transmission lines 132a and 132b shown in FIGS. 14 and 15, for example, in a case where the power transmission line 132b on the back side as viewed from the camera 10 side is selected as the first subject, in a case where the focus information of the first subject is to be acquired at the intersection portion between the power transmission lines 132a and 132b, the focus information of the power transmission line 132a on the front side may be erroneously acquired.

In a case where the focus information is erroneously acquired, there is a high possibility that the curve of the power transmission line 132b cannot be appropriately calculated. Therefore, the first power transmission line is selected as the power transmission line closest to the camera 10, that is, the power transmission line 132a in the cases of FIGS. 14 and 15. Accordingly, in a case where the focus information is acquired at a plurality of positions in the first power transmission line, the focus information of the power transmission line closest to the camera 10 can be accurately acquired.

### <Upper Limit of Tilt Angle of Camera and Control of Camera Position>

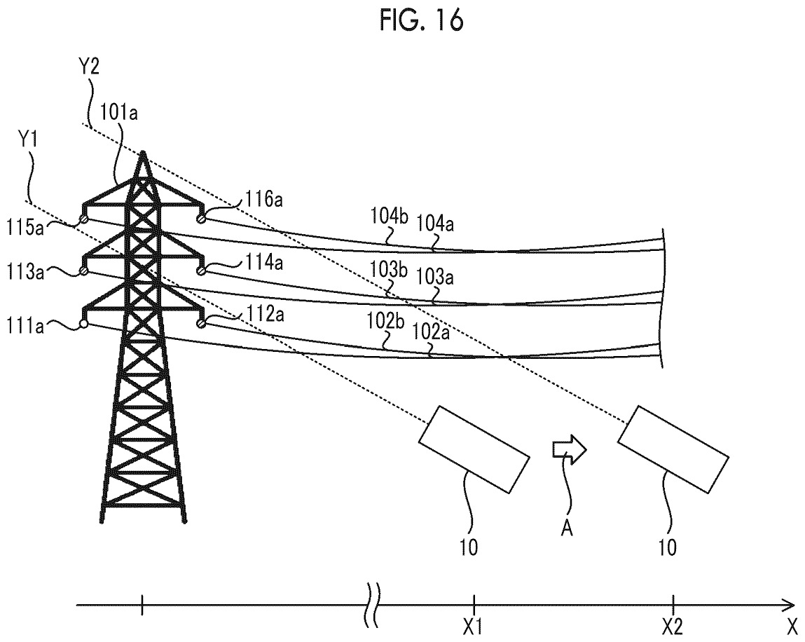

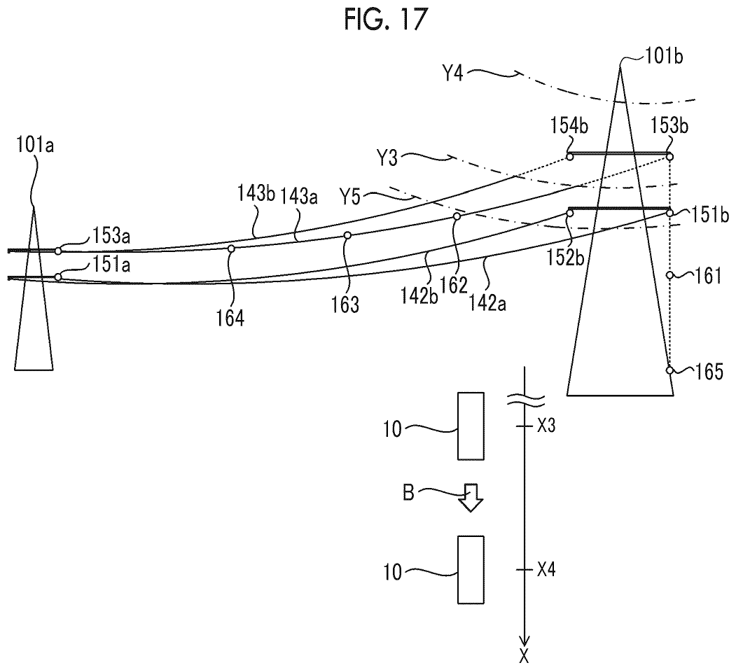

FIG. 16 is a diagram in which the camera 10 that images the steel tower 101a and the power transmission lines 102a, 102b, 103a, 103b, 104a, and 104b is viewed from a lateral direction of the camera 10. FIG. 17 is a diagram in which the camera 10 that images the steel towers 101a and 101b and power transmission lines 142a, 142b, 143a, and 143b is viewed from the rear of the camera 10.

Since there is a limit on the tilt angle depending on the type of the revolution mechanism 16 to which the camera 10 is attached, in a case where the distance between the camera 10 and the steel towers 101a and 101b is short, the tilt angle required for imaging near the end point of the power transmission line may exceed the tilt upper limit angle of the revolution mechanism 16, and a part of the power transmission line may not be imaged.

The camera 10 shown in FIGS. 16 and 17 is in an imaging state in a case where the tilt angle of the revolution mechanism 16 is adjusted to the upper limit angle. In FIG. 16, in a case where the imaging position of the camera 10 is a distance X1, the upper range that can be imaged by the camera 10 is an imaging range Y1, and in a case where the imaging position of the camera 10 is a distance X2 longer than the distance X1, the upper range that can be imaged by the camera 10 is an imaging range Y2. In addition, in FIG. 17, in a case where the imaging position of the camera 10 is a distance X3, the upper range that can be imaged by the camera 10 is an imaging range Y3, and in a case where the imaging position of the camera 10 is a distance X4 longer than the distance X3, the upper range that can be imaged by the camera 10 is an imaging range Y4.

As shown in FIG. 16, in a case where the distance between the camera 10 and the steel tower 101a is short (for example, in a case of the distance X1), the end point 114a of the power transmission line 103b, the end point 115a of the power transmission line 104a, and the end point 116a of the power transmission line 104b cannot be imaged. In addition, as shown in FIG. 17, in a case where the distance between the camera 10 and the steel tower 101b is short (for example, in a case of the distance X3), the end point 153b of the power transmission line 143a and the end point 154b of the power transmission line 143b cannot be imaged.

Therefore, for example, in the case of FIG. 16, in order to enable the end point 114a of the power transmission line 103b, the end point 115a of the power transmission line 104a, and the end point 116a of the power transmission line 104b to be imaged, the camera 10 and the installation position of the revolution mechanism 16 are moved to the distance X2 longer than the distance X1 as indicated by the arrow A. Similarly, in the case of FIG. 17, in order to enable the end point 153b of the power transmission line 143a and the end point 154b of the power transmission line 143b to be imaged, the camera 10 and the installation position of the revolution mechanism 16 are moved to the distance X4 longer than the distance X3 as indicated by the arrow B.

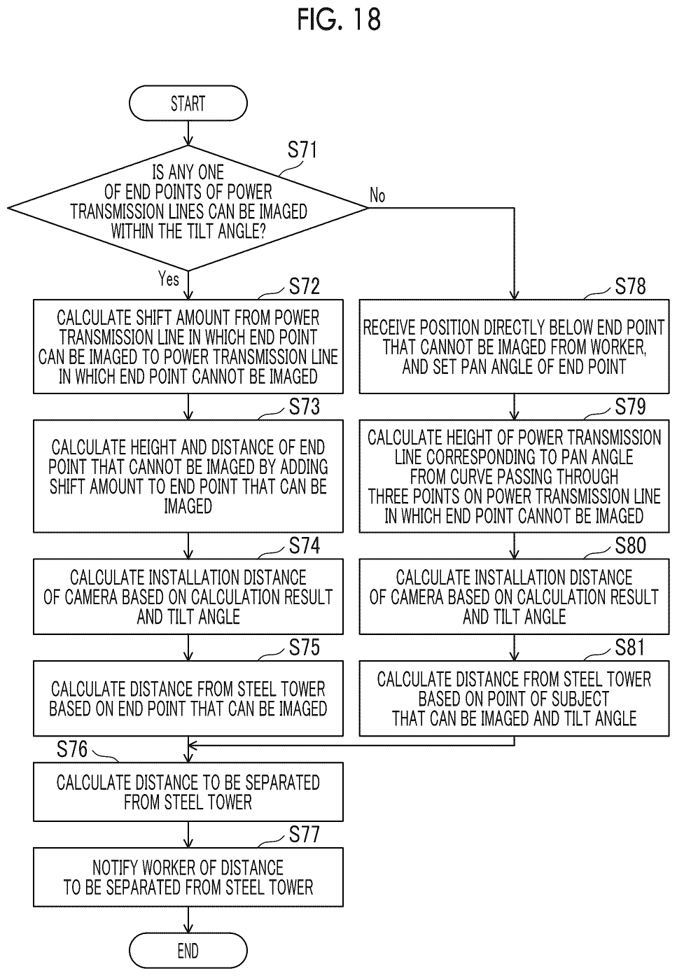

FIG. 18 is a flowchart for calculating an imaging distance of the camera 10 for imaging the power transmission line. In a case where, for example, an imaging distance calculation button (not illustrated) is pressed to detect the imaging position of the camera 10, the CPU 60A of the management apparatus 11 starts processing shown in FIG. 18.

In a case where the plurality of power transmission lines as the imaging target are imaged from the current installation position of the camera 10, the CPU 60A determines whether or not any one of the end points of the power transmission lines can be imaged within the tilt angle of the camera 10 (step S71). For example, in a case where the power transmission lines 142a, 142b, 143a, and 143b shown in FIG. 17 are imaged, the CPU 60A determines whether or not there is a power transmission line in which the entire power transmission line from one end part to the other end part can be imaged among the power transmission lines.

In step S71, in a case where any one of the end points of the power transmission lines can be imaged within the tilt angle of the camera 10 (step S71: Yes), the CPU 60A compares the power transmission line in which the end point can be imaged with the power transmission line in which the end point cannot be imaged, and calculates the shift amount between the two power transmission lines (step S72). For example, in FIG. 17, in a case where the imaging position of the camera 10 is the distance X3, the end point 151b of the power transmission line 142a can be imaged within the tilt angle of the camera 10, but the end point 153b of the power transmission line 143a cannot be imaged. In that case, a point on the power transmission line 143a, which can be imaged by the camera 10 at the imaging position at the distance X3, is selected, and a shift amount between the selected point (for example, the end point 153a on the side opposite to the end point 153b) and the end point 151a corresponding to the end point 153a of the power transmission line 143a in the power transmission line 142a is calculated.

Next, the CPU 60A calculates the height and the distance of the end point that cannot be imaged by adding the shift amount calculated in step S72 to the end point of the power transmission line that can be imaged (step S73). For example, in FIG. 17, the height of the end point 153b of the power transmission line 143a that cannot be imaged from the camera 10 and the distance from the camera 10 are calculated by adding the shift amount of the end point 153a of the power transmission line 143a with respect to the end point 151a of the power transmission line 142a to the end point 151b of the power transmission line 142a.

Next, the CPU 60A calculates, based on the result (the height and the distance of the end point that cannot be imaged) calculated in step S73 and the maximum tilt angle of the camera 10, a distance at which the camera 10 needs to be installed from the subject (the steel tower to which the power transmission line is connected) in order to make the end point that cannot be imaged in the current situation into the end point that can be imaged (step S74). For example, in FIG. 17, in order to enable the end point 153b of the power transmission line 143a to be imaged by the camera 10, a distance at which the camera 10 needs to be installed from the steel tower 101b is calculated.

Next, the CPU 60A calculates the distance from the steel tower to the current position at which the camera 10 is installed based on the end point of the power transmission line where the end point can be imaged in step S72 (step S75). For example, in FIG. 17, the distance X3, which is the current imaging position of the camera 10, is calculated based on the end point 151b of the power transmission line 142a that can be imaged.

Next, the CPU 60A calculates the distance at which the camera 10 is to be separated from the steel tower based on the distance calculated in step S74 and the distance calculated in step S75 (step S76). For example, in FIG. 17, the moving distance for moving the imaging position of the camera 10 from the distance X3 to the distance X4 is calculated.

Next, the CPU 60A displays the distance at which the camera 10 is to be separated from the steel tower, which is calculated in step S76, on the display 13a, for example, to notify the worker (step S77).

On the other hand, in step S71, in a case where neither of the end points of the power transmission lines can be imaged within the tilt angle of the camera 10 (step S71: No), the CPU 60A receives a position directly below the end point of the power transmission line that cannot be imaged from the worker, and sets the pan angle of the end point (step S78). For example, in FIG. 17, it is assumed that neither of the power transmission lines 142a, 142b, 143a, and 143b can image the end points 151b, 152b, 153b, and 154b, which is one of the end points, and the upper range that can be imaged by the camera 10 is an imaging range Y5. In this case, for example, the worker is instructed to designate any position in a range in which the camera 10 can perform imaging, which is the position directly below the end point 153b of the power transmission line 143a. The position is set as, for example, a directly below designation position 161. The pan angle of the designated directly below designation position 161 is measured. By measuring the pan angle of the directly below designation position 161, the pan angle of the end point 153b of the power transmission line 143a that is located above the directly below designation position 161 and cannot be imaged can be set.

Next, the CPU 60A calculates a curve passing through three points that are points on the power transmission line other than the end points and that can be imaged by the camera 10 in the power transmission line in which the end points cannot be imaged, and calculates the height of the end point of the power transmission line based on the calculated curve and the pan angle of the end point of the power transmission line set in step S78 (step S79). For example, in FIG. 17, a curve passing through points 162, 163, and 164 on the line where the camera 10 can perform imaging, which are points on the power transmission line 143a in which the end point 153b cannot be imaged, is calculated. The height of the end point 153b of the power transmission line 143a is calculated based on the calculated curve and the pan angle of the end point 153b of the power transmission line 143a set by the pan angle of the directly below designation position 161.

Next, the CPU 60A calculates, based on the result (the height of the end point that cannot be imaged) calculated in step S79 and the maximum tilt angle of the camera 10, a distance at which the camera 10 needs to be installed from the subject (the steel tower to which the power transmission line is connected) in order to make the end point that cannot be imaged in the current situation into the end point that can be imaged (step S80). For example, in FIG. 17, in order to enable the end point 153b of the power transmission line 143a to be imaged by the camera 10, a distance at which the camera 10 needs to be installed from the steel tower 101b is calculated.

Next, the CPU 60A detects a point on the steel tower that can be imaged by the camera 10, which is a point located directly below the end point of the power transmission line that cannot be imaged, and calculates the distance from the steel tower to the current position at which the camera 10 is installed based on the detected point on the steel tower and the tilt angle of the camera 10 for imaging the point (step S81). For example, in FIG. 17, a point located directly below the end point 153b of the power transmission line 143a and a point on the steel tower 101b that can be imaged by the camera 10, for example, a point 165 on the steel tower is detected. The distance from the steel tower to the current imaging position of the camera 10 is calculated based on the detected point 165 on the steel tower and the tilt angle of the camera 10 for imaging the point 165 on the steel tower.

Next, the CPU 60A calculates the distance at which the camera 10 is to be separated from the steel tower based on the distance calculated in step S80 and the distance calculated in step S81 (step S76). Then, the CPU 60A displays the distance at which the camera 10 is to be separated from the steel tower, which is calculated in step S76, on the display 13a, for example, to notify the worker (step S77). Accordingly, it is possible to easily specify the installation position of the camera 10 with respect to the subject.

### <Zoom Amount of Zoom Lens Corresponding to Imaging Distance>

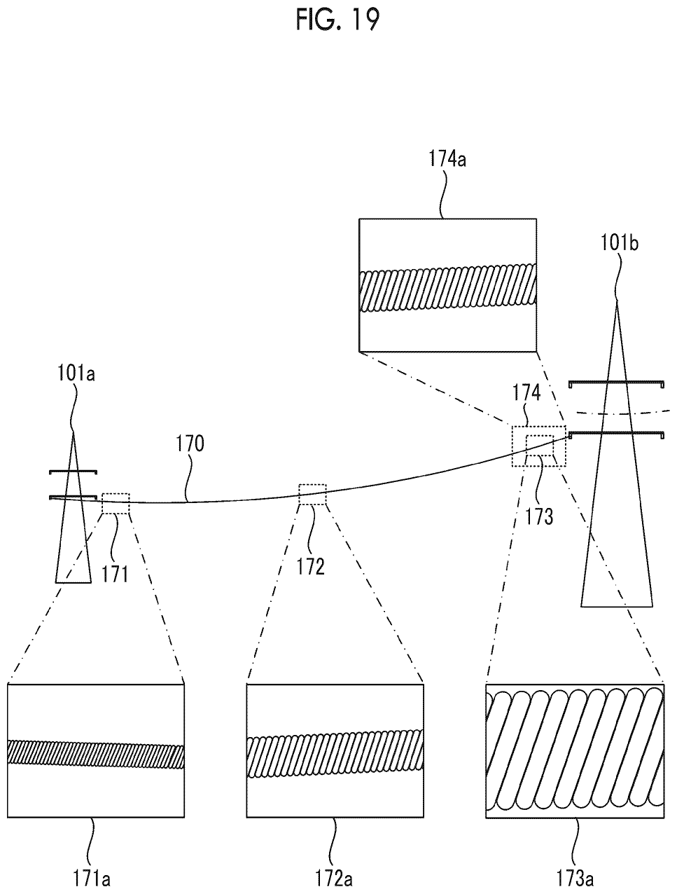

FIG. 19 is a diagram showing an example of an image obtained by performing zoom imaging at a plurality of positions where imaging distances are different. As shown in FIG. 19, a power transmission line 170 is connected between the steel tower 101a and the steel tower 101b. The camera 10 that images the power transmission line 170 is installed at a position closer to the steel tower 101b than to the steel tower 101a. That is, the distance from the camera 10 to the steel tower 101b is shorter than the distance from the camera 10 to the steel tower 101a.

A plurality of different power transmission line positions 171, 172, and 173 are selected as positions on the power transmission line 170, and images obtained by imaging the power transmission line positions 171, 172, and 173 in a state where the camera 10 is adjusted to the telephoto end are telephoto images 171a, 172a, and 173a. The power transmission line position 171 is a position close to the steel tower 101a, and the power transmission line position 173 is a position close to the steel tower 101b. Therefore, the distance from the camera 10 is the shortest at the power transmission line position 173 and the longest at the power transmission line position 171.

In a case where the power transmission line positions 171, 172, and 173 are imaged in a state where the camera 10 is adjusted to the telephoto end, since the power transmission line position 173 is close to the camera 10, the telephoto image 173a may be excessively enlarged more than necessary. In that case, the zoom amount of the zoom lens 15B2 may be changed (zoomed out) to an angle of view at which at least a resolution required for inspecting the power transmission line can be obtained to perform imaging.

For example, the zoom lens 15B2 may be zoomed out (the angle of view may be increased) until the angle of view is changed to the changed angle of view 174 at which the telephoto image 174a having the same resolution as the telephoto image 172a of the power transmission line position 172 can be obtained to perform imaging.

The zoom-out change amount, for example, may be set to be the same resolution as the position of the power transmission line on the farthest side or may be set to satisfy a resolution that is set in advance. Accordingly, it is possible to suppress an increase in the number of imaging locations of the power transmission line 170 in the imaging path, and it is possible to shorten the imaging time.

### <Management of Imaging Information>

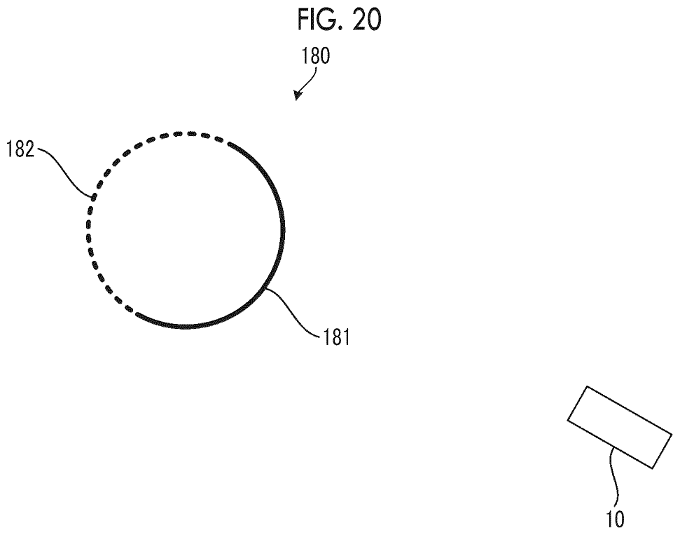

FIG. 20 is a diagram showing a state in which a subject is imaged by a camera. As shown in FIG. 20, in a case where the camera 10 that images the power transmission line 180 is installed on one side surface side of the power transmission line 180 with respect to the power transmission line 180, an opposite outer peripheral portion 182 of the power transmission line 180 on the side that does not face the camera 10 is not imaged, while a facing outer peripheral portion 181 of the power transmission line 180 on the side facing the camera 10 is imaged by the camera 10.

In this case, the captured image of the imaged facing outer peripheral portion 181 is stored in the memory 60C or the secondary storage device 14 in association with the information on the pan/tilt value of the camera 10. Accordingly, in a case where the power transmission line 180 is imaged again, it is possible to recognize which outer peripheral portion of the power transmission line 180 is imaged in the previously captured image. In addition, in a case where the power transmission line 180 is imaged using the drone, it is possible to easily specify and image an image other than the imaged outer peripheral portion.

### <Display of Subject Disposed to Overlap Each Other>

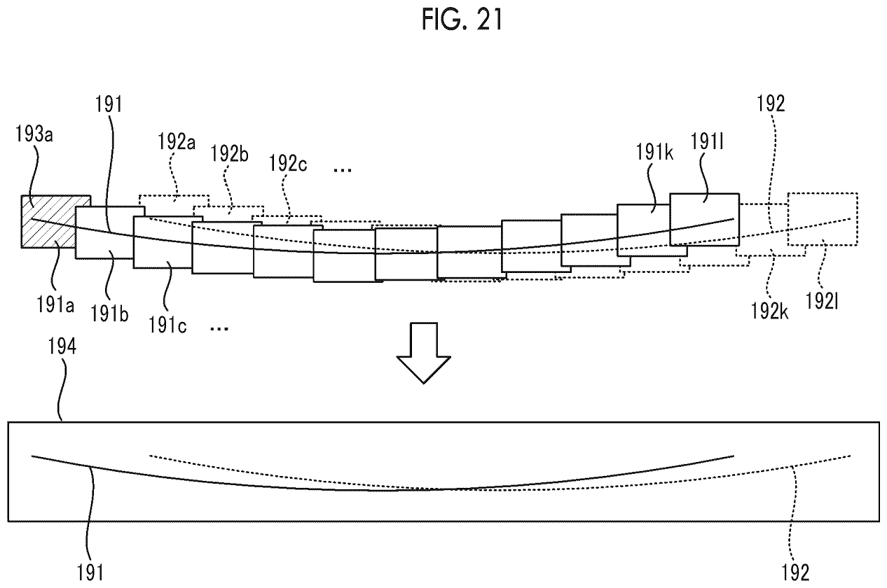

FIG. 21 is a diagram imaging two power transmission lines disposed to overlap each other in a front-rear direction. As shown in FIG. 21, a plurality of captured images 191a to 1911 of a power transmission line 191 obtained by the divided imaging on the imaging path of the power transmission line 191 disposed on a side (front side) closer to the camera 10 with respect to the camera 10, and a plurality of captured images 192a to 1921 of a power transmission line 192 obtained by the divided imaging on the imaging path of the power transmission line 192 disposed on a side (rear side) farther from the camera 10 with respect to the camera 10 are displayed.

The plurality of captured images 191a to 1911 of the power transmission line 191 are displayed on a front layer (first layer), and the plurality of captured images 192a to 1921 of the power transmission line 192 are displayed on a rear layer (second layer). In addition, the background portion (for example, the diagonal line portion 193a of the captured image 191a) in the plurality of captured images 191a to 1911 of the power transmission line 191 displayed on the front layer is displayed transparently. As described above, in a case where the two power transmission lines 191 and 192 are disposed to overlap each other as viewed from the camera 10, the composite image 194 is generated by combining images such that the power transmission line 191 closer to the camera 10 is seen in front of the power transmission line 192 farther from the camera 10.

As a result, it is possible to generate the composite image 194 such that the power transmission line 192 of the rear layer is seen through the transparent background portion of the power transmission line 191. In addition, it is possible to generate the composite image 194 in which the focus is on the power transmission line 191 closer to the camera 10 and the power transmission line 192 farther from the camera 10, respectively.

### <Display of Designated Subject>

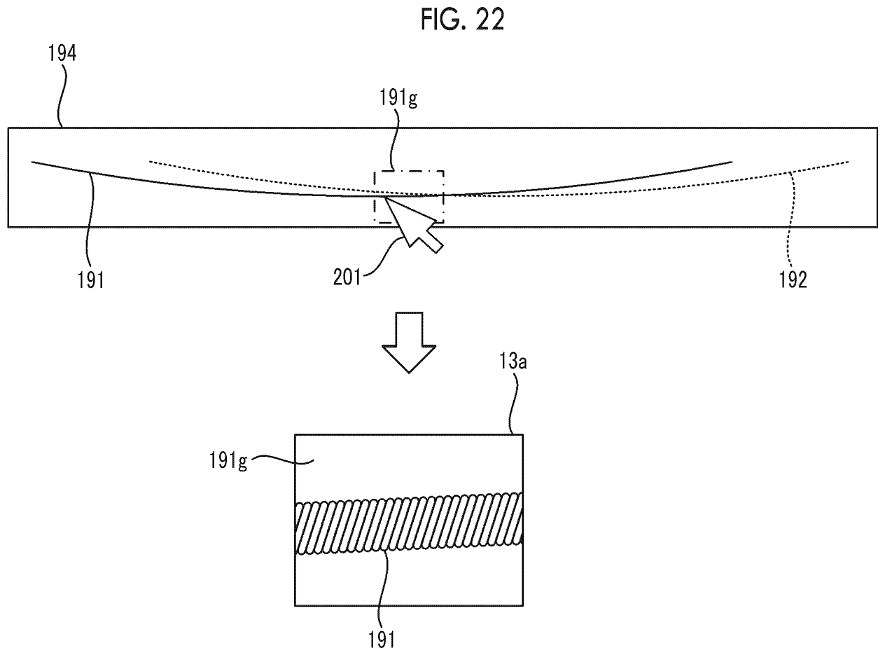

FIG. 22 is a diagram showing the composite image 194 of the two power transmission lines disposed to overlap each other in the front-rear direction. The composite image 194 is the same as the composite image 194 in FIG. 21 described above, and is an image obtained by combining the plurality of captured images 191a to 1911 obtained by performing the divided imaging on the imaging path of the power transmission line 191 and the plurality of captured images 192a to 1921 obtained by performing the divided imaging on the imaging path of the power transmission line 192. The captured images 191a to 1911 of the power transmission line 191 and the captured images 192a to 1921 of the power transmission line 192 are stored in the memory 60C or the secondary storage device 14 in association with the position information on the composite image 194.

As shown in FIG. 22, in a case where the worker clicks on any position with the cursor 201 on the composite image 194, the power transmission line closer to the clicked position among the power transmission lines 191 and 192 is selected. Then, in the selected power transmission line, the captured image including the clicked position is specified.

For example, it is assumed that the position clicked with the cursor 201 in the composite image 194 is close to the power transmission line 191. In this case, the power transmission line 191 is selected, and, for example, the captured image 191g among the captured images 191a to 1911 of the power transmission line 191 including the position clicked with the cursor 201 is specified.

Then, the specified captured image 191g is read out from the memory 60C and is displayed on the display 13a in an enlarged manner. As a result, in the composite image 194 in which a plurality of subjects (power transmission lines 191 and 192 and the like) are displayed, it is possible to easily display a predetermined captured image in any power transmission line, and it is possible to improve usability.

<Management of Imaging Information Imaged from Two Locations>

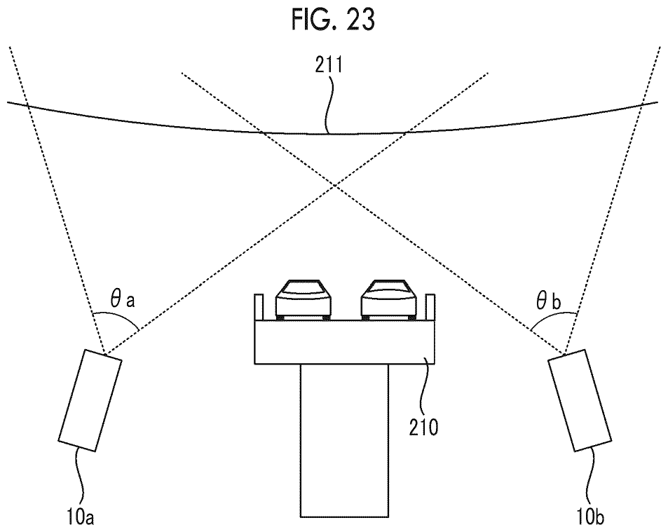

FIG. 23 is a diagram showing a state in which a power transmission line is imaged by cameras 10a and 10b installed at two locations. As shown in FIG. 23, for example, the power transmission line 211 that crosses an elevated road such as a highway 210 has a blind spot on one side and the entire power transmission line 211 may not be imaged by only the camera 10a installed on one side. In FIG. 23, the range in which the camera 10a can perform imaging is an angle of view θa. The range in which the camera 10b can perform imaging is an angle of view θb.

In such a case, by installing another camera 10b on the other side of the highway 210 and combining the captured image of the camera 10a and the captured image of the camera 10b, it is possible to image the entire power transmission line 211. The imaging information imaged by the camera 10a is stored in the memory 60C or the secondary storage device 14 as information on the camera 10a related to the power transmission line 211.

The imaging information imaged by the camera 10b is stored in the memory 60C or the secondary storage device 14 as information on the camera 10b related to the power transmission line 211. The imaging information includes, for example, installation locations of the cameras 10a and 10b, a formula of a curve of the power transmission line 211, a pan/tilt value, a zoom value, information on a focus position, and the like. In this way, by storing the imaging information of the power transmission line 211 imaged by each camera in association with the power transmission line 211, respectively, it is possible to efficiently manage the imaging information without overlapping each other.

### <Storage Medium of Information Processing Program>

In each of the management controls described above, the example has been described in which the information processing program of each embodiment is stored in the storage 60B of the management apparatus 11 and the CPU 60A of the management apparatus 11 executes the information processing program in the memory 60C, but the technique of the present disclosure is not limited to this.

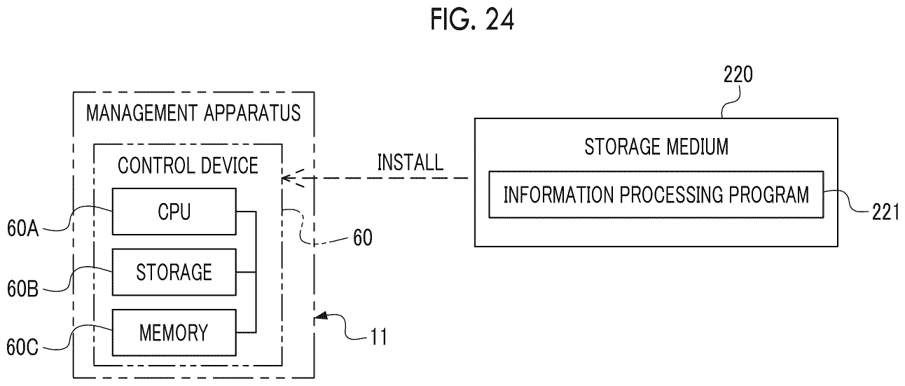

FIG. 24 is a diagram showing an example of an aspect in which the information processing program for management control is installed in the control device 60 of the management apparatus 11 from a storage medium in which the information processing program is stored. As shown in FIG. 24 as an example, an information processing program 221 may be stored in a storage medium 220 which is a non-temporary storage medium. In a case of the example shown in FIG. 24, the information processing program 221 stored in the storage medium 220 is installed in the control device 60, and the CPU 60A executes each of the above-described processing according to the information processing program 221.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-133011) filed on Aug. 24, 2022, the content of which is incorporated in the present application by reference.

### EXPLANATION OF REFERENCES

1: imaging system
10, 10a, 10b: camera
11: management apparatus
12: communication line
13a, 43B: display
13b: keyboard
13c: mouse
14: secondary storage device
15: optical system
15B: lens group
15B1: anti-vibration lens
15B2: zoom lens
16: revolution mechanism
17, 21: lens actuator
19: computer
22: BIS driver
23: OIS driver
25: imaging element
25A: light-receiving surface
27: imaging element actuator
28: lens driver
29, 45: correction mechanism
31: DSP
32: image memory
33: correction unit
34, 66 to 68, 79, 80: communication I/F
35, 60C: memory
36, 60B: storage
37, 60A: CPU
38, 70: bus
39, 47: position sensor
40: shake amount detection sensor
43: UI system device
43A, 62: reception device
60: control device
71: yaw-axis revolution mechanism
72: pitch-axis revolution mechanism
73, 74: motor
75, 76: driver
101a, 101b: steel tower
102, 102a, 102b, 102n, 103a, 103b, 104a, 104b, 132a, 132b, 142a, 142b, 143a, 143b, 170, 180, 191, 192, 211: power transmission line
111a to 111d: position
112a, 113a, 114a, 115a, 116a, 151a, 151b, 152b, 153a, 153b, 154b: end point
121: end part
161: directly below designation position
162 to 164: point on line
165: point on steel tower
171 to 173: power transmission line position
171a, 172a, 173a, 174a: telephoto image
174: changed angle of view
181: facing outer peripheral portion
182: opposite outer peripheral portion
191a to 1911, 192a to 1921: captured image
193a: diagonal line portion
194: composite image
201: cursor
210: highway
220: storage medium
221: information processing program
Y1 to Y5: imaging range

What is claimed is:

1. A control device comprising:
a processor that controls an imaging apparatus and an imaging direction changing device capable of changing an imaging direction of the imaging apparatus, wherein
the processor is configured to:
set a first imaging path, which is an imaging path of a first subject, based on imaging information at discrete positions within the first subject and subject information related to the first subject; and
control imaging of the first subject based on the first imaging path.

2. The control device according to claim 1, wherein
the subject information is a shape of the first subject in a two-dimensional plane.

3. The control device according to claim 1, wherein
the imaging information is a control value based on an angle of view of the imaging apparatus for imaging the discrete positions.

4. The control device according to claim 3, wherein
the imaging information includes a control value of the imaging direction changing device for imaging the discrete positions.

5. The control device according to claim 3, wherein
the imaging information includes a distance between the first subject and the imaging apparatus for imaging the discrete positions.

6. The control device according to claim 3, wherein
the imaging information includes a focus position of the imaging apparatus for imaging the discrete positions.

7. The control device according to claim 6, wherein
the imaging apparatus includes a zoom lens, and
the processor is configured to acquire the focus position of the imaging apparatus by causing the imaging apparatus to execute distance measurement in a state where the zoom lens is set to a telephoto region.

8. The control device according to claim 1, wherein
the first imaging path includes a control value for dividing and imaging the first subject.

9. The control device according to claim 1, wherein
the discrete positions include at least one of: three adjacent points among a plurality of points in the first subject; or two points respectively at an end of the first subject and one point different from the two points among the plurality of points.

10. The control device according to claim 9, wherein
the two points respectively at an end of the first subject are respectively located in an end region of the first subject.

11. The control device according to claim 1, wherein
the discrete positions are calculated based on an analysis result of an image obtained by imaging the first subject.

12. The control device according to claim 1, wherein
the processor is configured to:
acquire difference information between a first position within the first subject and a second position within a second subject;
set a second imaging path, which is an imaging path of the second subject, based on the first imaging path and the difference information; and
control imaging of the second subject based on the second imaging path.

13. The control device according to claim 12, wherein
the first position is a position of a region of the first subject close to the imaging apparatus, and
the second position is a position of a region of the second subject close to the imaging apparatus.

14. The control device according to claim 12, wherein
the first subject is a subject closer to the imaging apparatus than the second subject.

15. The control device according to claim 12, wherein
the processor is configured to:
calculate, in a case where the imaging in the second imaging path is determined to be impossible within a movable range of the imaging direction changing device, an installation position of the imaging direction changing device at which the imaging in the second imaging path is possible within the movable range of the imaging direction changing device; and
output the installation position.

16. The control device according to claim 12, wherein
the processor is configured to:
generate a composite image by combining a plurality of captured images of the first subject obtained by performing imaging in the first imaging path by the imaging apparatus and a plurality of captured images of the second subject obtained by performing imaging in the second imaging path by the imaging apparatus, and output the composite image to a display device, wherein the composite image, in which one of the first subject and the second subject closer to the imaging apparatus is seen in front of other of the first subject and the second subject farther from the imaging apparatus, is generated based on distance information between the first subject and the imaging apparatus and distance information between the second subject and the imaging apparatus.

17. The control device according to claim 1, wherein
the imaging apparatus includes a zoom lens,
the first imaging path includes information on an imaging distance, and
the processor is configured to change a zoom amount of the zoom lens in accordance with the imaging distance in control of the imaging of the first subject based on the first imaging path.

18. The control device according to claim 17, wherein
the zoom amount is an amount corresponding to a set resolution.

19. The control device according to claim 1, wherein
the processor is configured to store information related to an imaging angle of the first subject based on the first imaging path in a storage device in association with the first subject.

20. The control device according to claim 1, wherein
the processor is configured to:
generate a composite image obtained by combining each of captured images obtained by performing imaging in the first imaging path by the imaging apparatus, and output the composite image to a display device;
receive designation of a position within the composite image; and
output a captured image corresponding to the designated position among the captured images to the display device.

21. The control device according to claim 1, wherein
the processor is configured to store information related to a plurality of times of imaging of the first subject controlled in a state where the imaging apparatus is installed at different locations in a storage device in association with the first subject.

22. The control device according to claim 1, wherein
the first subject is a linear structure that does not fit entirely within a set angle of view.

23. An imaging system comprising:
an imaging apparatus;
an imaging direction changing device capable of changing an imaging direction of the imaging apparatus; and
a control device that controls the imaging apparatus and the imaging direction changing device, wherein
a processor included in the control device is configured to:
set a first imaging path, which is an imaging path of a first subject, based on imaging information at discrete positions within the first subject and subject information related to the first subject; and
control imaging of the first subject based on the first imaging path.

24. A control method by a control device that controls an imaging apparatus and an imaging direction changing device capable of changing an imaging direction of the imaging apparatus, the method comprising:
via a processor of the control device,
setting a first imaging path, which is an imaging path of a first subject, based on imaging information at discrete positions within the first subject and subject information related to the first subject; and
controlling imaging of the first subject based on the first imaging path.

25. A non-transitory computer readable medium storing a control program of a control device that controls an imaging apparatus and an imaging direction changing device capable of changing an imaging direction of the imaging apparatus, the program causing a processor of the control device to execute a process comprising:
setting a first imaging path, which is an imaging path of a first subject, based on imaging information at discrete positions within the first subject and subject information related to the first subject; and
controlling imaging of the first subject based on the first imaging path.
